(19) United States
(12) Patent Application Publication
(10) Pub. No.: US 2024/0375987 A1
(43) Pub. Date: Nov. 14, 2024

(54) WASTE PROCESSING APPARATUS

(71) Applicant: Cranfield University, Cranfield (GB)

(72) Inventor: Leon Matthew Williams, Cranfield (GB)

(21) Appl. No.: 18/690,567

(22) PCT Filed: Sep. 7, 2022
(86) PCT No.: PCT/GB2022/052269

§ 371 Date: Mar. 8, 2024

(30) Foreign Application Priority Data
Sep. 9, 2021 (GB) 2112883.0

(51) Int. Cl. C02F 9/00; B01D 29/56; B01D 29/66; B01D 36/00; B01D 53/18; B01D 53/26; B01D 61/36; C02F 1/00; C02F 1/44; C02F 11/10; C02F 11/13; C02F 103/00; E03D 9/00

(52) U.S. Cl. CPC C02F 9/00; B01D 29/56; B01D 29/668; B01D 36/006; B01D 36/008; B01D 53/18; B01D 53/263; B01D 61/364; B01D 61/366; E03D 9/00; B01D 2252/103; B01D 2257/80; B01D 2311/04; B01D 2313/243; B01D 2313/501; C02F 1/001; C02F 1/447; C02F 11/10; C02F 11/13; C02F 2103/005; C02F 2301/046; C02F 2301/08; C02F 2303/16

(57) ABSTRACT

A human waste processing system adapted to process both human solid and liquid waste deposited into a toilet or similar vessel and to process the waste for further use and/or convenient disposal. The present system is specifically configured for use with low-water-volume flush toilets and dry toilets. In particular, the present system is configured to separate solid waste and liquid waste with liquid waste being processed via a plurality of sequential filtration stages and with the solid waste being processed by thermal decomposition such as pyrolysis/torrefaction processing.

### FIELD OF INVENTION

The present invention relates to human waste processing apparatus and in particular, although not exclusively, to a toilet waste system configured to process both solid and liquid waste.

### BACKGROUND

According to the World Health Organisation as reported in June 2019, around 2 billion people do not have basic sanitation facilities such as toilets or latrines. Of these, an estimated 673 million defecate in the open, for example in street gutters, behind bushes or into open bodies of water. Poor sanitation is linked to transmission of diseases such as cholera, diarrhoea, dysentery, hepatitis A, typhoid and polio. In particular, inadequate sanitation, is estimated to cause around 432 k diarrhoea deaths annually. Additionally, poor sanitation has been proven to reduce human wellbeing and social and economic development.

Attempts to address the various problems associated with no or little sewage infrastructure has included with the use of non-flushing or chemical toilets and that may be conveniently supplied and installed in remote and rural communities. It is generally required that such toilets be environmentally friendly, can be easily maintained and require low energy consumption.

Non-flushing toilets have existed for many years including for example incinerator toilets as described within U.S. Pat. Nos. 3,020,559 and 3,230,913. These types of toilet use a coiled electrical heating element to incinerate/burn the faeces with all emitted gases and smoke exhausted via ducts into the surrounding environment. Whilst such devices are effective to kill bacteria and other pathogens within the faeces, they are typically very energy intensive and generate harmful NOX and SOX gases (together with carbon dioxide) that are released into the surrounding environment.

Chemical toilets collect human excreta in holding tank and use chemicals to minimise odours and in some cases initiate chemical breakdown of the excreta to inhibit the growth of harmful bacteria and pathogens. However, such toilets typically require large holding tanks and significant volumes of disinfectant and deodorising chemicals. Biocides, alcohols and ammonium-based compounds are typically used. However, the collected and chemically treated waste is required to be transported to large-scale sewage processing plants before it can be discharged safely and preferably utilised for applications such as within fertilisers.

Accordingly, there is a need for improved apparatus and methods for the safe, effective and environmentally sustainable collection and treatment of human waste particularly in deprived regions with poor sanitation facilities and connection to sewage treatment networks.

### SUMMARY OF THE INVENTION

It is an objective of the present invention to provide a waste processing system including apparatus and method to process mixed solid and liquid waste including, in particular, faeces and urine according to environmentally sustainable, effective and convenient pathways. It is a specific objective to provide a human waste processing system to process waste, encompassing human faeces and urine, via an energy efficient and environmentally sustainable process.

It is a further specific objective to provide a waste processing system involving the processing of predominantly liquid waste (i.e. urine) via first optimised filtration pathway in combination with the parallel processing of predominantly solid waste (i.e. faeces) via a second energy efficient pathway that importantly minimises and preferably eliminates emission of harmful gases into the environment.

The objectives are achieved via specific apparatus and methods for the parallel processing of urine and faeces via respective pathways. According to the present concept, the predominantly liquid processing and predominantly solid processing assemblies are interconnected via respective conduits, inlet and outlet ports, valves, filters and tanks so as to provide a fully integrated system having a modular construction. Human liquid waste is processed via the predominantly liquid processing assembly with the fully filtered liquid permeate/distillate being optionally recycled to a front-end toilet for flushing or cleaning. Additionally, a scrubber liquid generated during the predominantly solid waste processing may be fed to the predominantly liquid processing assembly for purging operations and/or for filtration treatment by the liquid processing assembly.

According to the present concept, the predominantly solid waste processing assembly and methods utilise a pyrolysis process to thermally decompose solid waste (to effectively eliminate pathogens and bacteria within faeces) and generate a safe and biologically benign product char that may be disposed of conveniently and/or used for one or more applications. Preferably, the present solid waste processing assembly and system is configured for torrefaction processing to convert generally solid biomass into a product char via a mild form of pyrolysis involving heating temperatures optionally between 200° C. to 350° C. Such a configuration is beneficial to kill pathogens and bacteria within the biomass without releasing harmful product gases such as NOX and SOX pollutants directly into the environment. The present torrefaction thermochemical treatment apparatus and method is operational at atmospheric pressure and utilises an oxygen depleted environment that is convenient and energy efficient to create and maintain.

According to a preferred embodiment, the present concept comprises a pyrolysis chamber (within which the torrefaction process is implemented) and a liquid scrubber unit coupled in fluid communication with the pyrolysis chamber to receive gases and/or moisture vapour. Such an arrangement is advantageous to avoid emission of pyrolysis product gases and vapour directly into the surrounding environment. By exhausting such gases and moisture vapour directly into the body of a scrubber liquid, the gases are captured and may be subsequently reacted and/or otherwise chemically treated via subsequent downstream liquid processing apparatus and procedures.

It is a further specific objective to provide a toilet and/or human waste processing system and apparatus to process human liquid waste to filter and to remove solid matter and solid particulates optionally in addition to toxins and bacteria so as to generate a processed liquid suitable for further applications such as hand washing, toilet flushing, crop irrigation etc. These objectives are achieved via the predominantly liquid processing assembly and system that utilises a variety of sequential staged filter treatment processes and units adapted specifically to separate sequentially solid matter from liquid waste. The present liquid processing assembly and system is configured specifically to require little or zero flushing water and/or additional liquids and chemicals as part of the filtration process. In particular, the present liquid processing assembly and system utilises liquid processing loops for the efficient use of liquid and additional materials and apparatus. The present assembly and system is designed specifically to minimise the number of working components and to facilitate transport to remote locations and for installation and use within confined spaces. Moreover, the present system attempts to minimise the use of chemicals and material that are not suitable for recycling or further uses. Membrane distillation according to the present system is advantageous to separate non-volatile components, such as ions, macro-molecules and colloidal particles from a condensate liquid generated by the distillation-condensation cycle and the water-repelling nature of the membrane.

Reference within the specification to ‘permeate’ encompasses a liquid that is the result of vapourisation and condensation via a membrane distillation unit. Such a term includes a condensate, a vapour, a gas, a product and the condensation of vapour or a gas within or outside the membrane module/unit.

According to a first aspect of the present concept there is provided waste processing apparatus comprising: a) a liquid waste processing assembly comprising: at least one pre-filter treatment unit having a liquid flow inlet and outlet and a particulate filter to separate particulate suspended within waste liquid; a membrane distillation unit having a membrane distillation vessel with an internal filter membrane, a primary flow liquid inlet and outlet and a permeate flow outlet, the primary flow liquid inlet connected in fluid communication to the liquid flow outlet of the pre-filter treatment unit; and b) a solid waste processing assembly comprising: a pyrolysis unit having at least one heater and a pyrolysis chamber provided with a solid waste inlet, a solid waste outlet, a gas/moisture vapour outlet; and a scrubber unit having a scrubber tank to contain a scrubber liquid and provided with a liquid outlet, a gas outlet and a gas/moisture vapour inlet coupled to the gas/moisture vapour outlet of the pyrolysis chamber.

Optionally, the apparatus comprises a toilet having a toilet outlet coupled to the liquid flow inlet of the pre-filter treatment unit and the solid waste inlet of the pyrolysis unit. The toilet may have any configuration and the present system is compatible with any waste input type. Optionally the toilet may be a standard flushing pedestal toilet, a squat type toilet, a waterless flushing toilet, a toilet with a vacuum type flush, a dry or semi-dry toilet, a chemical toilet, a portable toilet or a permanent/fix position toilet. Optionally, the apparatus further comprises a mixed waste actuator to transport and/or separate the solid and liquid waste, the actuator positioned in a waste flow direction between the toilet outlet and said liquid flow inlet and said solid waste inlet. Preferably, the apparatus comprises a linear and/or rotary actuator to transport and separate the solid and liquid waste and positioned in a fluid flow direction upstream of the pre-filter treatment unit. Preferably, linear and/or rotary actuator is a solid-liquid screw conveyor. Optionally the linear and/or rotary actuator is a mechanical device which converts rotary motion into linear motion. Such a device includes a circular conveyor, a rack and pinion, a belt, mesh or rib conveyor. Preferably, the screw conveyor comprises a central shaft from which extends a helical blade. Preferably, the solid-liquid coarse filter is positioned radially adjacent the solid-liquid coarse filter. Preferably, the solid-liquid coarse filter is positioned at a wall of a jacket or housing of the solid-liquid screw conveyor. Preferably, the solid-liquid screw conveyor is inclined at an inclined angle extending upwardly from a solid-liquid receiving chamber forming part of a toilet.

Optionally, the apparatus further comprises a holding tank coupled to or provided at the toilet to receive and/or store solid and liquid waste, the liquid flow outlet of the pre-filter treatment unit coupled to the holding tank.

Optionally, the liquid outlet of the scrubber unit is coupled to the primary flow liquid inlet of the membrane distillation unit. Optionally, the apparatus comprises a liquid drain conduit coupling in fluid communication the scrubber unit and the holding tank to enable transfer of a scrubber liquid from the scrubber unit to the holding tank. Optionally, the permeate flow outlet is coupled in fluid in communication to the toilet to enable a supply of a permeate liquid from the membrane distillation unit to the toilet.

Optionally, the pre-filter treatment unit comprises a pre-filter storage tank. Optionally, the pre-filter treatment unit comprises: a first pre-filter treatment unit having a first pre-filter storage tank and a first particulate filter; and a second pre-filter treatment unit having a second pre-filter storage tank and a second particulate filter. Optionally, the first particulate filter comprises a first mesh pore size; and the second particulate filter comprises a second mesh pore size being less than the first mesh pore size. Optionally, the pore size of the first and second filters may be approximately the same. Optionally, the first particulate filter comprises a mesh pore size in a range 50 to 800 μm, 50 to 150 μm or 80 to 120 μm; and the second particulate filter comprises a mesh pore size in a range 0.5 to 50 μm, 0.5 to 20 μm, 0.5 to 10 μm or 0.5 to 5 μm. Reference within the specification to ‘mesh pore size’ refers to the size of each aperture or opening of the mesh according to conventional standards ISO 565:1990 and ISO 3310-1:2000 and EN 933-1. Preferably, the first and second pre-filter treatment unit comprise respective mountings to releasably mount the first and second particulate filters to enable removal and insertion of the first and second particulate filters at the respective first and second pre-filter treatment units. Such mountings may include clips, bayonet, screw or push-fit connections to provide convenient assembly and disassembly of the filtration units and the interchange of filter meshes of different pore size. Optionally, each particulate filter comprises a cap, a hollow cylindrical mesh, a base and respective seals.

Optionally, wherein the pre-filter treatment unit comprises a respective purge valve and purge outlet connected in fluid communication to the particulate filter, the apparatus further comprising at least one return flow conduit extending between the front end holding tank and the pre-filter treatment unit to provide a filtration circuit. Optionally, the first and second pre-filter treatment units comprise a respective purge valve and purge outlet connected in fluid communication to the respective particulate filters, the apparatus further comprising respective return flow conduits extending from the purge outlets to a front end holding tank and/or the least one pre-filter treatment unit to provide a filtration circuit. Optionally, the purge valve is connected to a supply flow conduit extending between the pump and the inlet of the pre-filtration unit. Preferably, the apparatus further comprises a supply flow conduit connected in fluid communication to the front-end holding tank and the liquid flow inlet of the pre-filter treatment unit.

Optionally, the apparatus comprises a solid-liquid coarse filter to separate solid waste from the waste liquid positioned in a fluid flow direction upstream of the pre-filter treatment unit. The coarse filter may comprise a mesh/port comprising a 1000 μm mesh, of a material such as a polyester, nylon or stainless-steel mesh. Preferably, the mesh is mounted at the filter via a mounting that enables the convenient interchange of the mesh. Preferably, the solid-liquid coarse filter comprises a cartridge configuration to enable convenient interchange. Optionally, the coarse filter comprises a flange, grate or screen comprising apertures, perforations, slots or elongate gaps (e.g. of approximately 1 mm) to remove unbound liquid and paper pulp. Such apertures or slots work cooperatively with the mesh to provide filtration of solid and liquid waste.

Optionally, the apparatus further comprises a flow actuator, optionally comprising a pump, connected in a fluid flow direction between the solid-liquid coarse filter and the pre-filter treatment unit. Preferably, the flow actuator is a pump connected in a fluid flow direction between the solid-liquid coarse filter and the pre-filter treatment unit. Reference within this specification to a ‘pump’ may be a positive-displacement pump, a rotary pump, a reciprocating-type positive displacement pump such as a piston pump, plunger pump or a diaphragm pump, or other pump mechanism such as a linear-type positive displacement pump for the manual or automated or semi-automated transport of liquid. Optionally, the apparatus comprises a plurality of pumps positioned at different locations within the fluid network.

Optionally, the apparatus further comprises a holding tank positioned in a fluid flow direction between the pre-filter treatment unit and the membrane distillation unit. Preferably, the apparatus comprises a first distillation flow pump to drive a flow of liquid from the holding tank to the membrane distillation unit. Preferably, the apparatus further comprises a permeate collection reservoir to collect liquid permeate output from the permeate flow outlet. Optionally, the apparatus further comprises a first distillation flow pump to drive a flow of liquid from the holding tank to the membrane distillation unit; a permeate collection reservoir to collect liquid permeate output from the permeate flow outlet; wherein the membrane distillation unit further comprises a permeate flow inlet connected in fluid flow with the permeate flow outlet to provide a permeate flow loop through the filter membrane; a second distillation flow pump connected in fluid flow with the permeate flow loop. Preferably, the apparatus further comprises a second distillation flow pump connected in fluid flow with the permeate flow loop. Preferably, the apparatus further comprises a permeate output filter connected in fluid communication to an outlet of the permeate collection reservoir to receive and collect output from the membrane distillation unit.

Optionally, the present membrane distillation unit comprises a configuration being any one of: direct contact membrane distillation (DCMD); air gap membrane distillation (AGMD); sweep gas membrane distillation (SGMD); vacuum membrane distillation (VMD).

Optionally, the membrane distillation unit comprises an air gap membrane distillation configuration and the apparatus further comprises: a cooling fluid network having a fluid flow conduit to contain a cooling fluid, a cooling fluid tank, and a cooling fluid pump to drive a flow of the cooling fluid through the conduit. Optionally, the membrane distillation unit comprises a vacuum membrane distillation configuration and the apparatus further comprises: a vacuum manifold having a vacuum pump and a condenser connected to the membrane distillation vessel to drive a flow of permeate from the membrane to the condenser.

Optionally, the system comprises a permeate output filter, and optionally a carbon filter including any one or a combination of: charcoal, activated charcoal, an antimicrobial.

Preferably, an aperture of the gas/moisture vapour inlet from which a gas/moisture vapour is configured to enter the tank is positioned at a first region of the tank and an aperture of the gas outlet through which a gas is configured to vent from the tank is positioned at a second region spatially separated from the first region. Optionally, the scrubber tank comprises a scrubber liquid and an aperture of the gas/moisture vapour inlet from which a gas/moisture vapour is configured to enter is positioned submerged within the scrubber liquid and an aperture of the gas outlet through which a gas is configured to vent from the scrubber tank is positioned above and clear of the scrubber liquid; and wherein an aperture of the liquid outlet from which a liquid is configured to flow from the scrubber tank is positioned intermediate the aperture of the gas/moisture vapour inlet and the aperture of the gas outlet. Such a configuration provides that the exhaust for gases/vapour from the pyrolysis chamber are always vented directly into the scrubber liquid. Accordingly, exhaust gases from the pyrolysis chamber are not vented directly into the environment and are vented exclusively into the scrubber liquid prior to any release into the environment.

Preferably, an aperture of the liquid outlet from which a liquid is configured to flow from the tank is positioned intermediate the aperture of the gas/moisture vapour inlet and the aperture of the gas outlet. This provides an overflow weir effect to maintain a predetermined volume of liquid within the scrubber tank. In particular, as more scrubber liquid is condensed within the tank (from oxygen and water vapour exhausted from the pyrolysis chamber) excess scrubber liquid is allowed to overflow from the liquid outlet into a downstream liquid processing facility/system. Advantageously, the scrubber liquid is replenished so as to control pH and the concentration of dissolved nitrogen and sulphur compounds that would otherwise create an acidic environment and lead to corrosion problems. In particular, and preferably, the tank is elongate and configured to collect and retain a pre-determined volume of a scrubber liquid within a lower region of the tank, the liquid outlet positioned between respective lengthwise ends of the tank to provide an overflow weir to maintain the pre-determined volume of the scrubber liquid within the tank. Optionally, the scrubber unit may further comprise a solid-phase reactive insert positioned within the tank to react chemically with a gas and/or a liquid within the tank. The reactive insert may comprise an alkaline insert configured to balance pH or other chemical composition and/or configured to neutralise or reduce the concentration of biological and/or harmful compounds emitted from the drying and/or pyrolysis process. Preferably, the gas/moisture vapour inlet is coupled directly to the gas/moisture vapour outlet exclusively via a one-way valve.

Optionally, the pyrolysis unit further comprises a waste actuator positioned within the chamber to compress and/or facilitate movement of the waste to a region of the chamber adjacent the heater. Preferably, the waste actuator is elongate and is configured to be rotatable about a longitudinal axis. Preferably, a lower region of the waste actuator comprises a radially enlarged section. Preferably, the radially enlarged section may be formed as a drum and comprises at least one helical projection extending axially and radially outward at an external facing surface of the drum. Optionally, wherein at least a portion of the chamber and the actuator are cylindrical and separated from one another by an annular gap region, the actuator being rotatably mounted within the chamber. Preferably, the actuator and/or chamber comprise a conical section having a respective conical guide surface to facilitate movement of the solid waste into the gap region under gravity. Preferably, an external facing surface of the actuator is positioned opposite an internal facing surface of the chamber and comprises at least one helical rib extending lengthwise around the longitudinal axis of the actuator. Optionally, the heater is positioned to at least partially surround the chamber at a location adjacent the annular gap region.

Preferably, the apparatus further comprises a flap hingeably mounted to extend over an aperture of the solid waste inlet through which the solid waste is configured to enter the chamber wherein the flap and/or a perimeter region of an internal facing surface of the chamber surrounding the aperture is profiled via a groove and/or a projection.

Preferably, the apparatus further comprises a char collection trap coupled in internal communication to receive solid waste char from the pyrolysis chamber, the collection trap positioned below the chamber. The char collection trap is positioned immediately below a char outlet located at a lowermost terminal end of the pyrolysis chamber. Thermally decomposed solid waste is configured to fall under gravity from the waste outlet into the char collection trap.

Preferably, the heater is positioned to at least partially surround the chamber at a location adjacent the annular gap region. Optionally, the heater comprises a plurality of independent heating collars positioned circumferentially around a heating zone of the pyrolysis chamber. The heating zone is preferably positioned at a lowermost region of the pyrolysis chamber. The heating collars may be operated and controlled independently and/or collectively. The apparatus optionally comprises temperature sensors to monitor a heating temperature at the pyrolysis chamber and to regulate automatically and/or semi-automatically the heating via thermostatic control.

Optionally, the apparatus further comprises a wiper blade extending radially outward from the actuator towards an internal facing surface of the chamber. Preferably, the wiper blade is positioned in close or near touching contact with the conical guide surface and is rotatable with the actuator so as to dislodge solid matter and facilitate downward transfer into the lower heating zone.

Optionally, wherein the pyrolysis unit comprises valves and/or seals to prevent or inhibit a flow of air into the chamber so as to provide an oxygen depleted environment within the chamber suitable for pyrolysis.

According to a further aspect of the present concept there is provided a method of processing human waste comprising: a) processing liquid waste via a liquid waste processing assembly including: receiving liquid waste from a toilet at a pre-filter treatment unit; filtering the waste liquid at the pre-filter treatment unit using a particulate filter; transferring filtered waste liquid from the pre-filter treatment unit to a membrane distillation unit; filtering the waste liquid through a filter membrane within a membrane distillation vessel of the membrane distillation unit; and outputting liquid permeate from the membrane distillation unit; and b) processing solid waste via a solid waste processing assembly including: thermally decomposing solid waste within a chamber using pyrolysis;

exhausting a flow of a gas from said chamber generated by the pyrolysis into a body of a scrubber liquid contained within a scrubber tank, the scrubber tank positioned in internal fluid communication with the chamber.

Optionally, the method comprises transporting and/or separating the solid and liquid waste using a mixed waste actuator, the actuator positioned in a waste flow direction between an outlet of the toilet and a liquid flow inlet of the at least one pre-filter treatment unit and a solid waste inlet of the pyrolysis unit; and/or prior to the step of filtering the waste liquid at the pre-filter treatment unit, filtering the waste liquid via a solid-liquid coarse filter to separate solid waste from waste liquid, a mesh pore size of the solid-liquid coarse filter being greater than a mesh pore size of the particulate filter of the pre-filter treatment unit.

Optionally, the method further comprises: purging solid waste entrapped at the pre-filter treatment unit via a purge valve connected to the pre-filter treatment unit; and transferring the solid waste purged from the pre-filter treatment unit via a return flow conduit to a front-end holding tank and/or an inlet of the pre-filter treatment unit.

Optionally, the method comprises prior to the step of filtering the waste liquid at the pre-filter treatment unit, filtering the waste liquid via a solid-liquid coarse filter to separate solid waste from waste liquid, a mesh pore size of the solid-liquid coarse filter being greater than a mesh pore size of the particulate filter of the pre-filter treatment unit. Preferably, the method comprises transporting solid waste and waste liquid at the solid-liquid coarse filter using a solid-liquid screw conveyor. Preferably, the method further comprises heating the waste liquid after the step of filtering the waste liquid by the pre-filter treatment unit and prior to filtration at the membrane distillation unit. Preferably, the method further comprises circulating the waste liquid through the membrane distillation unit via a feed loop and simultaneously collecting liquid permeate from the membrane distillation unit. Preferably, the method further comprises filtering permeate output by the membrane distillation unit using a permeate output filter, the permeate output filter comprising any one or a combination of: charcoal, activated charcoal, an antimicrobial

Optionally, the method comprises drying the solid waste within the chamber prior to the step of thermally decomposing the solid waste, wherein a heating temperature of the step of drying is less than a heating temperature of the step of thermally decomposing the solid waste. Preferably, the method comprises collecting water within the scrubber tank during the step of drying the solid waste to generate the scrubber liquid within the tank. Water in the form or moisture vapour and oxygen are released from the solid waste during the drying step and are transferred from the pyrolysis chamber into the scrubber unit where they condense to form the scrubber liquid. This initial drying phase is advantageous to regenerate the scrubber liquid and control its chemical composition, pH and accordingly minimise corrosion and other adverse effects associated with an acidic liquid contained within a metal environment. Preferably, the pyrolysis unit and the scrubber unit are formed from a metal and optionally steel in particular stainless steel.

Optionally, the method further comprises collecting water within the scrubber tank during the step of drying the solid waste to generate the scrubber liquid within the scrubber tank; and maintaining a pre-determined volume of water within the scrubber tank by allowing excess water to exit the scrubber tank via a liquid outlet positioned to provide a weir arrangement at the scrubber tank.

Optionally, wherein the heating temperature of the step of drying is in a range 30° C. to 150° C., 40° C. to 120° C., 40° C. to 100° C. or 50° C. to 90° C.; and/or a heating temperature of the step of thermally decomposing is in a range 180° C. to 400° C., 200° C. to 400° C., 200° C. to 300° C. or 220° C. to 270° C. The step of thermally decomposing the solid matter is preferably a torrefaction process (mild form of pyrolysis) at a temperature of around or slightly above 200° C. and optionally in a range 200° C. to 320° C. Processing at this temperature range is advantageous to minimise harmful emissions from the pyrolysis unit including for example syngases in particular NOₓ and SOₓ, as well as CO and NH₃. Additionally, torrefaction of the solid biomass has been found to be energy efficient by minimising the electrical energy required to generate high heating temperatures associated with other pyrolysis processes that typically involve temperatures in the range 310° C. to 540° C.

### BRIEF DESCRIPTION OF DRAWINGS

A specific implementation of the present invention will now be described, by way of example only, and with reference to the accompanying drawings in which:

FIG. 1 is a perspective view of a modular waste processing system having a solid waste processing assembly including pyrolysis and emission scrubber units and a liquid waste processing assembly having a series of pre-filtration and membrane distillation units according to a specific implementation;

FIG. 2A is a first half of a schematic diagram of the modular waste processing system of FIG. 1 illustrating the flow pathways of solid and liquid matter through and between the solid and liquid waste processing assemblies according to a specific implementation;

FIG. 2B is a second half of schematic diagram of the modular waste processing system of FIG. 1 illustrating the flow pathways of solid and liquid matter through and between the solid and liquid waste processing assemblies according to a specific implementation;

FIG. 3 is a perspective view of a pre-filter arrangement forming part of the processing system of FIG. 1;

FIG. 4 is a magnified perspective view of one of the pre-filter units of the system of FIG. 1;

FIG. 5 is a magnified perspective view of part of a pre filter unit of the system of FIG. 1;

FIG. 6 is a perspective view of a membrane distillation unit forming part of the system of FIG. 1;

FIG. 7 illustrates schematically a liquid flow cycle through the membrane distillation unit of FIG. 6 including a feed loop and a permeate loop;

FIG. 8A is a perspective view of an operational loop of the membrane distillation unit of FIG. 6;

FIG. 8B is a perspective view of a cleaning loop associated with the membrane distillation unit of FIG. 6;

FIG. 9 is a perspective view of a filter membrane housed within the membrane distillation unit of FIG. 6;

FIG. 10A is a schematic view of the present membrane distillation unit having a direct contact membrane distillation (DCMD) configuration according to a specific implementation;

FIG. 10B is a schematic view of the present membrane distillation unit having a direct contact air gap membrane distillation (AGMD) configuration according to a specific implementation;

FIG. 10C is a schematic view of the present membrane distillation unit having a direct contact sweep gas membrane distillation (SGMD) configuration according to a specific implementation;

FIG. 10D is a schematic view of the present membrane distillation unit comprising a direct contact vacuum membrane distillation (VMD) configuration according to a specific implementation;

FIG. 11 is a schematic flow diagram of one operational flow pathway of part of the liquid waste processing system including the membrane distillation unit of FIG. 1;

FIG. 12 is a partial cross-sectional perspective view of a toilet forming a ‘front end’ unit of the waste processing system of FIG. 1;

FIG. 13 is an exploded perspective view of a lower region of the toilet of FIG. 12;

FIG. 14 is an underside exploded perspective view of selected upper components of the toilet of FIG. 12;

FIG. 15 is a downward exploded perspective view of selected upper components of the toilet of FIG. 12;

FIG. 16 is a cross-sectional view of an upper region of a screw conveyor forming part of the toilet of FIG. 12;

FIG. 17 is a perspective view of the screw conveyor of FIGS. 12 and 16;

FIG. 18A is a cross-sectional/transparent view of the toilet of FIG. 12 in a first rotational position according to a further specific implementation having a mechanical actuating link for actuating rotational movement of selected components according;

FIG. 18B is a cross-sectional/transparent view of the toilet of FIG. 12 in a second rotational position according to the specific implementation of FIG. 18A;

FIG. 18C is a cross-sectional/transparent view of the toilet of FIG. 12 in a third rotational position according to the specific implementation of FIG. 18A.

FIG. 19 is a perspective view of a pyrolysis and emission scrubber module forming part of the waste processing system of FIG. 1;

FIG. 20 is a cross sectional view of the pyrolysis and emission scrubber module of FIG. 19;

FIG. 21 is a perspective view of the emission scrubber unit of the module of FIG. 20 with selected components removed for illustrative purposes;

FIG. 22 is a perspective view of the pyrolysis unit of the module of FIG. 20 with selected components removed for illustrative purposes;

FIG. 23 is a perspective view of a lower region of the pyrolysis unit of the module of FIG. 20 with selected components removed for illustrative purposes;

FIG. 24 is a cross sectional view through the module of FIG. 20 according to a specific implementation.

### DETAILED DESCRIPTION OF PREFERRED EMBODIMENT OF THE INVENTION

A human waste processing system according to the present concept is adapted to process both human solid and liquid waste deposited into a toilet or similar vessel and to process the waste for further use and/or convenient disposal. The present system is specifically configured for use with low-water-volume flush toilets and ‘dry’ toilets. In particular, the present system is configured to separate solid waste and liquid waste deposited into a toilet or similar vessel with the liquid waste being processed via a plurality of sequential filtration stages (using a plurality of different types and configuration of filter units) and with the solid waste being processed via thermal decomposition (pyrolysis/torrefaction processing).

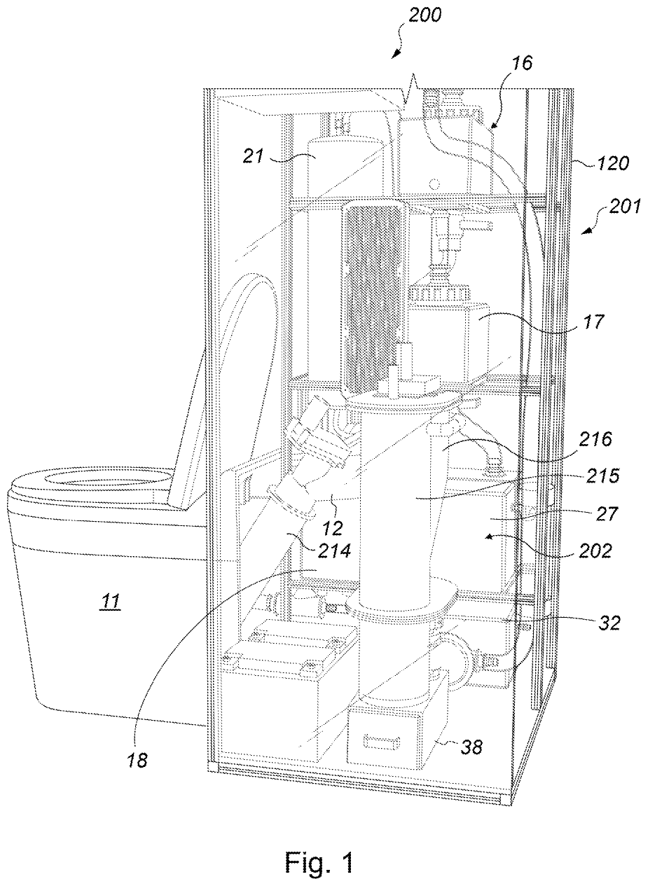

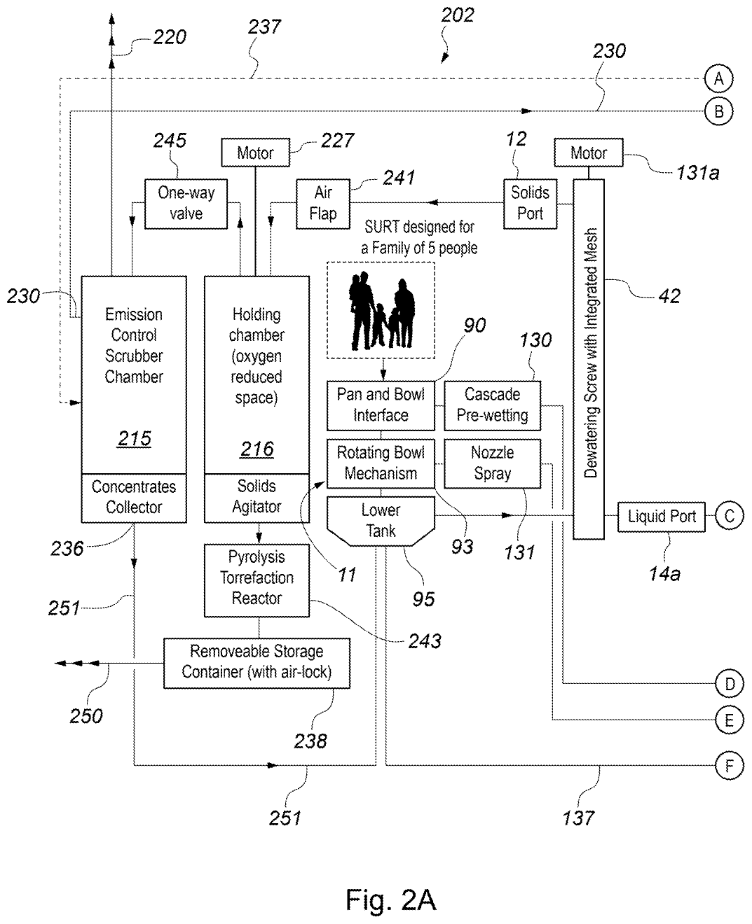

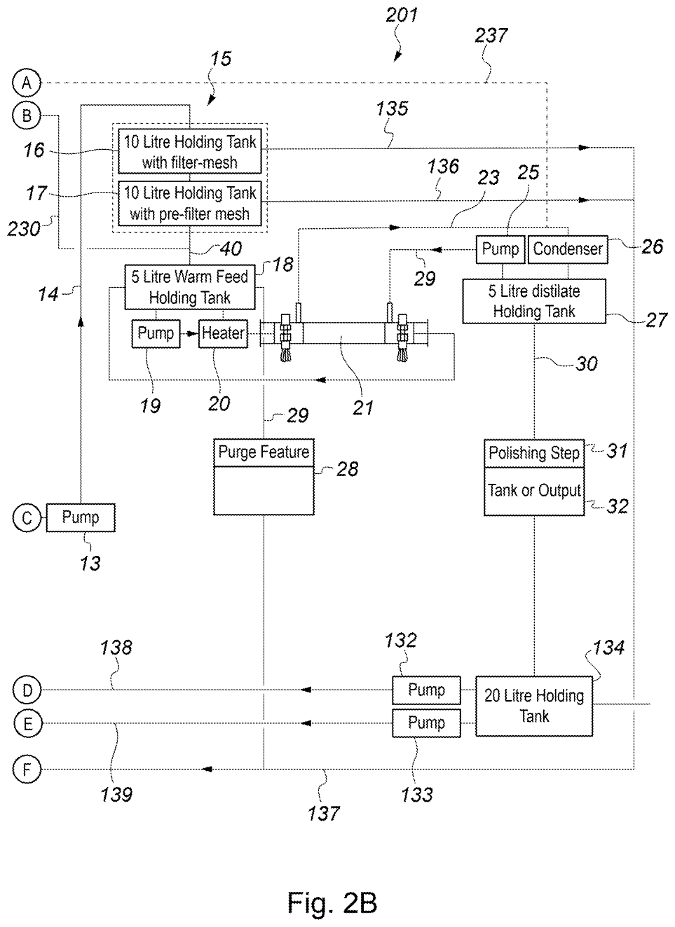

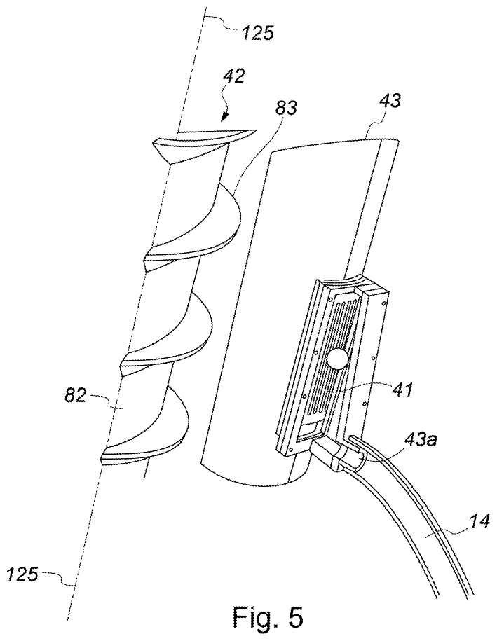

Referring to FIGS. 1, 2A and 2B, a human waste processing system 200 comprises a liquid waste processing module or assembly indicated generally by reference 201 and a solid waste processing module or assembly indicated generally by reference 202. The system 200 comprises what may be regarded as a ‘front end’ that includes an input vessel (toilet 11). Toilet 11 is provided with a solid waste outlet port 12 for the output of predominantly solid waste (faeces and paper) that is coupled in fluid communication to the solid waste processing module or assembly 202. Toilet 11 also comprises a liquid outlet or liquid drain 43a (FIG. 5) connected to the liquid waste processing module or assembly 201 and in particular a diaphragm pump 13 that is configured to pump and transport the predominantly liquid waste (received at toilet 11 and that has been at least partially separated from the deposited solid waste) to a prefiltration unit of liquid waste processing assembly 201.

The system 200 comprises a frame 120 supporting a variety of modular components including toilet 11 and the solid and liquid processing assemblies 202 and 201 that in turn include a pyrolysis module 216; an emission scrubber module 215; a solid and liquid transporter 214 coupled between the toilet 11 and the pyrolysis and emission scrubber modules 216, 215; a plurality of tanks and units (including pre-filter units 16, 17, membrane distillation unit 21, warm feed holding tank 18, permeate holding tank 27 and output tank 32). In use, solid and liquid waste is deposited within the toilet 11 following which it is transported to the pyrolysis module 216 via transporter 214 (configured to separate solid waste and liquid waste). The solid waste is transported to the solid treatment assembly 202 (in particular pyrolysis module 216) whilst the liquid waste is transported to the liquid treatment assembly 201. Treated liquid and solid waste may then be collected, disposed of and/or used for downstream applications and processes. The entire system 200 may be installed within stationary or mobile environments. In particular, the present system, apparatus and methods are configured for processing human solid and liquid waste without requiring an additional supply of liquid (for flushing purposes) and connection to a sewage outlet/network. Accordingly, the present apparatus and methods are adapted for installation and operation within a building or within a transport carriage that is not provided with a tanked or fresh waste supply and/or connection to a sewage network/treatment facility.

Referring to FIG. 5, system 200 is provided with a solid-liquid separator in the form of a screw conveyor 42 adapted to transport the solid waste upwardly against gravity. Such solid waste includes predominantly faeces and toilet paper. Screw conveyor 42 comprises an elongate shaft 82 (centred on a rotational axis 125) from which extends a helical blade 83, fin or thread. The helical path of blade 83 is relatively ‘open’ so as to have a large helical or taper angle (relative to axis 125). Additionally, shaft 82 comprises a minimised radius being relatively thin. Such configurations are advantageous to maximise transport of solid waste and to minimise clogging and blockage. The solid waste (faeces and toilet paper) has an important role on the sludge rheology and the screw conveyor is designed via the pitch, size and axially spacing of the helical blade 83 to avoid over compacting of the paper pulp, which may otherwise clog the solid outlet 12 and to reduce back-pressure and torque on the motor (not shown) that drives rotation of the conveyor 42 at the filter 41.

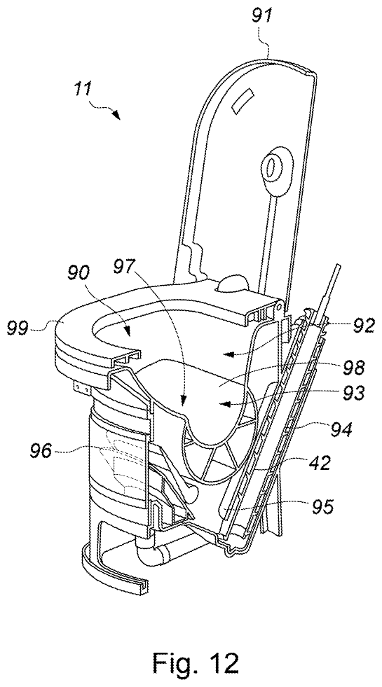

A relatively stiff polymer mesh filter 41 is mounted on the side wall of a jacket 94 (FIG. 12) that houses the screw conveyor 42. Optionally a pore size of mesh may be around 0.5 mm. Such a configuration is designed to provide a basic separation of bound and unbound liquid waste from the solid waste stream. Mesh filter 41, mounted at filtration unit 43, is provided with a liquid outlet 43a connectable to a ‘front end’ manifold 14 having a diaphragm pump 13. Accordingly, liquid waste separated from the solid waste by screw conveyor 42 and filter 41 is forced downstream through manifold 14 via diaphragm pump 13.

As indicated, the present system is configured for the parallel and integrated processing of the solid and liquid waste via the respective solid and liquid processing assemblies that are in turn integrated with one another via liquid and/or solid waste flow communication conduits, networks and pathways to provide a fully unified singular system.

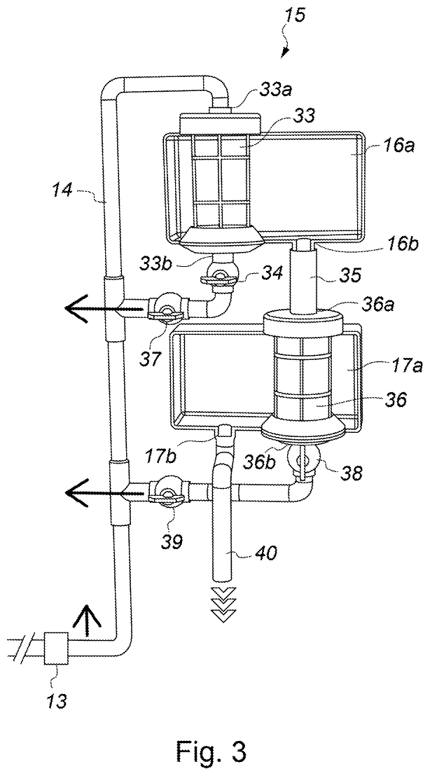

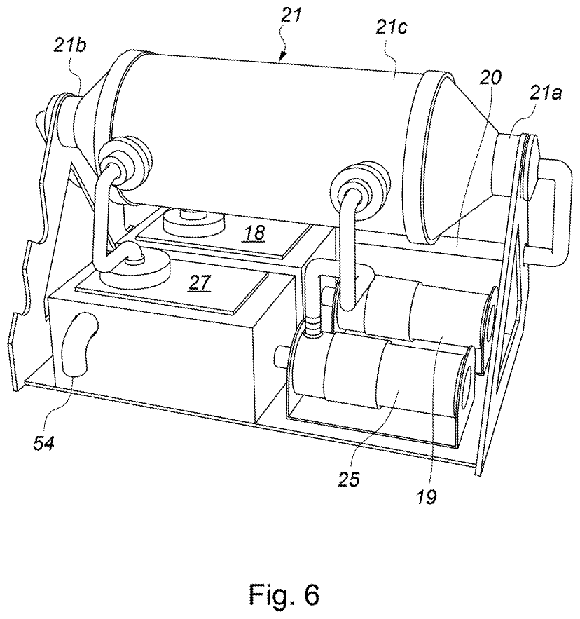

The apparatus and method for predominantly liquid waste processing will now be described referring to FIGS. 3 to 11. Referring to FIGS. 2B and 3, liquid waste processing assembly 201 further comprises a liquid pre-filtration unit 15 having a plurality of pre-filter units or modules for the sequential filtering of waste liquid output from the drainage port 43a. A first pre-filter unit 16 comprises a holding tank 16a and a mesh filter 33. A second pre-filter unit 17 also comprises a holding tank 17a and a mesh filter 36. The pre-filtration unit 15 is coupled in fluid communication with a warm feed holding tank 18 forming part of a feed (or primary liquid flow) loop associated with a membrane distillation unit 21. A diaphragm pump 19 is coupled in fluid communication with holding tank 18 and in flow communication with a heater 20 optionally being an electric heating coil/hot runner heating circle coil to provide a heating temperature in a range 40 to 80° C. and preferably around 65° C. The pump 19 and heater 20 are coupled in fluid communication to a membrane distillation unit 21 as described referring to FIGS. 6 to 8A.

Membrane distillation unit 21 further comprises a permeate loop 23 comprising a condenser 26 a second diaphragm pump 25, coupled in turn, to the membrane distillation unit 21 via loop conduit 24. A permeate holding tank 27 is coupled in fluid communication to pump 25 and condenser 26. A weir overflow arrangement is coupled to an output tank 32 via an outlet conduit 30. At least one filter such as an activated charcoal, silver impregnated charcoal, UV and/or biological filter 31 are provided at or immediately upstream of output tank 32. Assembly 201 further comprises purge components indicated generally by reference 28, coupled to the membrane distillation unit 21 via conduit 29 so as to provide a purging of entrapped solid material deposited/collected within the membrane distillation unit 21.

Referring to FIG. 3, waste liquid manifold 14 (extending downstream of the pump 13) is connected in fluid communication with filter 33 of the first pre-filter unit 16. Filter 33 comprises a purge outlet 33b coaxial with inlet 33a that, is in turn, coupled to manifold 14. A rotatable ball valve 34 provides control and a switching between the operational first mode (‘use’ status) of filter 33 and a second mode (‘purging’ status). A further rotatable ball valve 37 is connected in fluid communication downstream of ball valve 34. Valve 37 is connected to the wastewater supply manifold 14 to return the purged liquid (and solids) from filter 33 into the supply manifold 14 for re-supply to the first filter unit 16. According further implementations, ball valve 37 may be coupled alternatively or in addition to the toilet 11 and/or an intermediate holding tank from which waste liquid and solid particulate is delivered into the wastewater supply manifold 14.

A conduit 45 provides fluid communication between first pre-filter tank 16a and a second pre-filter 36 of the second pre-filter unit 17a. Conduit 35 extends between a liquid outlet 16b of tank 16a and an inlet 36a of second pre-filter 36. Conduit 35 is coupled to the inlet 36a of filter 36. As with the first filter unit 16, the second pre-filter 36 also comprises a coaxial outlet 36b provided with a rotatable ball valve 38 connected in fluid communication to a return ball valve 39 which is, in turn, coupled to the wastewater supply manifold 14 and/or the ‘front end’ of the solid and liquid waste collection tank. An outlet 17b of pre-filter tank 17a is coupled to the conduit 40 to transfer filtered liquid to the warm feed holding tank 18.

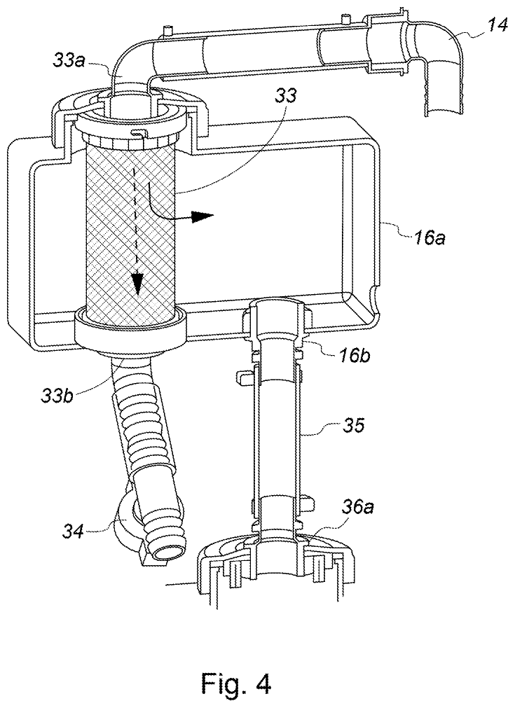

Referring to FIGS. 3 and 4, each of the filters 33, 36 comprise a hollow cylindrical mesh illustrated in FIG. 4 referring to the first pre-filter unit 16. The cylindrical mesh body extends between inlet 33a and outlet 33b. Each filter 33, 36 is modular to allow interchange of the mesh. According the specific implementation, filter 33 comprises a 400 or 900 μm mesh and filter 36 comprises a 1 to 10 μm polyester mesh (although may comprise a 400 or 900 μm mesh). Optionally the meshes are polyester. However, alternative mesh materials may be used for both or either filter including nylon, stainless steel etc. The aperture size of each mesh may be selected to suit the dietary habits of users of the current system with different mesh sizes being selected for optimised filtering of solid fats for example that may be at a higher concentration for carnivores relative to vegetarians. In use, waste liquid is delivered into a first pre-filter 33 via inlet 33a. The waste liquid is then filtered through the mesh walls laterally into the first tank 16a (as a consequence of the ball valve 34 being closed). The pre-filtered liquid then transfers to the second pre-filter 36 and into tank 17a via lateral flow through the filter mesh. The twice filtered waste liquid is then delivered to the warm feed holding tank 18 via conduit 40. In a cleaning or purging operation, accumulated fats and other solid bodies and particulates entrapped at the interior of each cylindrical pre-filter 33, 36 is purged back to either the supply manifold 14 or towards the front end toilet 11 (or initial solid and liquid holding tank). This purging is achieved via control and an opening of valves 34, 35, 38 and 39 which when create a turbulent liquid flow within each respective filter 33, 36 to dislodge the solid particulates and effectively wash each mesh filter. Such control may be manual and/or automated as described herein.

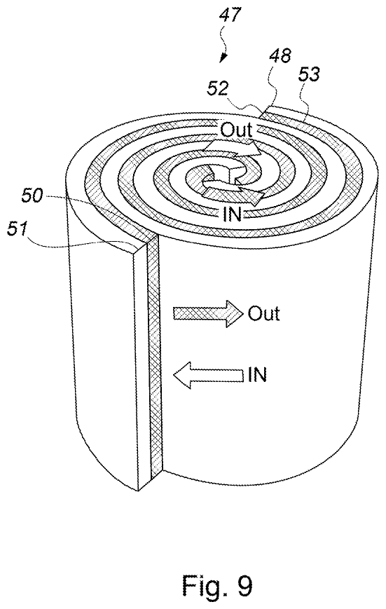

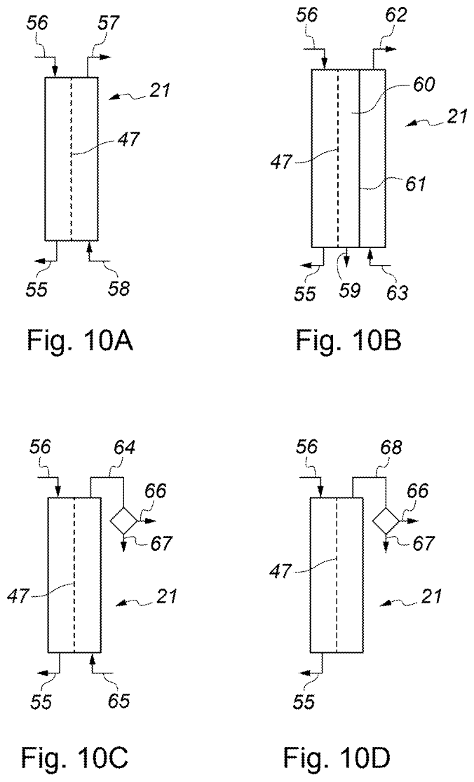

Referring to FIG. 6, the pre-filtered waste liquid is then transferred to membrane distillation unit 21 to undergo further filtration via membrane distillation. The present apparatus and system is compatible with conventional membrane distillation configurations including direct contact membrane distillation (DCMD), air gap membrane distillation (AGMD), vacuum membrane distillation (VMD) and inlet sweep gas membrane distillation (SGMD). As will be appreciated, these different types of membrane distillation differ via the type and configuration of the internal membrane material and auxiliary apparatus as described referring to FIGS. 10a to 10d. The specific implementation of membrane distillation within the present system is described with reference to DCMD. In particular, membrane distillation unit 21 comprises a housing 21a incorporating a membrane distillation material arranged in a roll as illustrated in FIG. 9. According to the specific embodiment, the DCMD internal filter material comprises four layers 48, 50, 51 and 52 arranged in a collective roll such that each layer follows a continuously curved path 53 from a radially outer perimeter region to a radial centre. The rolled configuration is energy efficient being a self-insulating counter-current module with low fowling/scaling resultant from the hydrophobic membrane materials. As will be appreciated, filtration occurs via internal distillation and condensation cycles and use of at least two different layers of materials as illustrated in FIG. 9. The microporous hydrophobic membrane 47 is configured to separate the aqueous solutions at different temperatures in which the hydrophobicity of the membrane prevents mass transfer of a liquid so as to create an internal gas-liquid interface. According to the specific implementation, for DCMD, the permeate-side comprises a condensation liquid (being the cleaned filtered liquid) that is in direct contact with the membrane. The hydrophobicity of the membrane provides full retention of non-volatile components such as ions, large macromolecules and colloidal particles (e.g., fats and other particulates typically present in human solid and liquid waste).

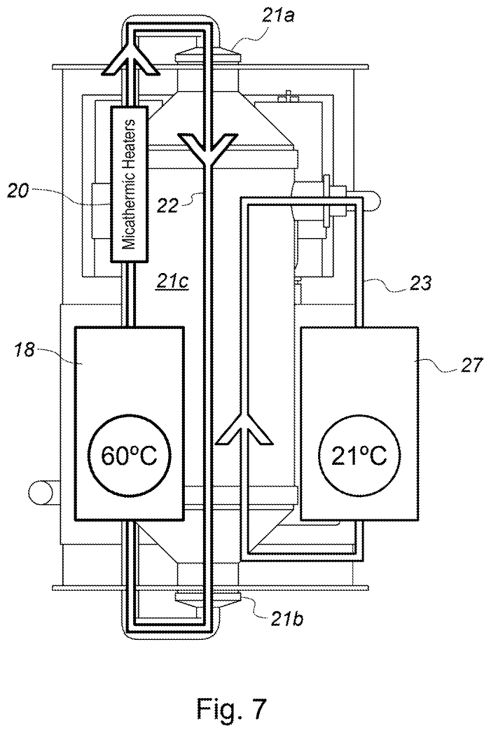

Referring to FIGS. 6 and 7, membrane distillation housing 21a comprises inlet 21a and outlet 21b aligned coaxially at each respective end of the housing 21a. Each inlet and outlet 21a, 21b, forms part of the feed loop 22 providing a waste liquid supply circuit that includes the warm feed holding tank 18, pump 19, heater 20 and membrane distillation unit 21. The membrane distillation unit 21 also comprises permeate loop 23 similarly flowing internally through the membrane 47 and including condenser 26, pump 25 and permeate holding tank 27. Importantly, the current apparatus is configured to provide elevated temperature filtering of the waste liquid that includes high concentrations of urea. Heater 20 is controllable to provide heating of liquid within feed loop 22 so as to avoid boiling of the feed loop liquid and in particular the generation of nitrogen gas within the membrane distillation unit 21. However, heater 20 is configured to provide sufficient heating to drive the membrane distillation process and the collection of the permeate/condensate so as to establish the separate feed and permeate loops 22, 23. According to the specific implementation, the permeate loop is controlled to operate at a liquid temperature of around 20° C. whilst the feed loop liquid may be maintained at around 60° C. Output of the permeate is via outlet 54 at holding tank 27 (optionally via a weir arrangement).

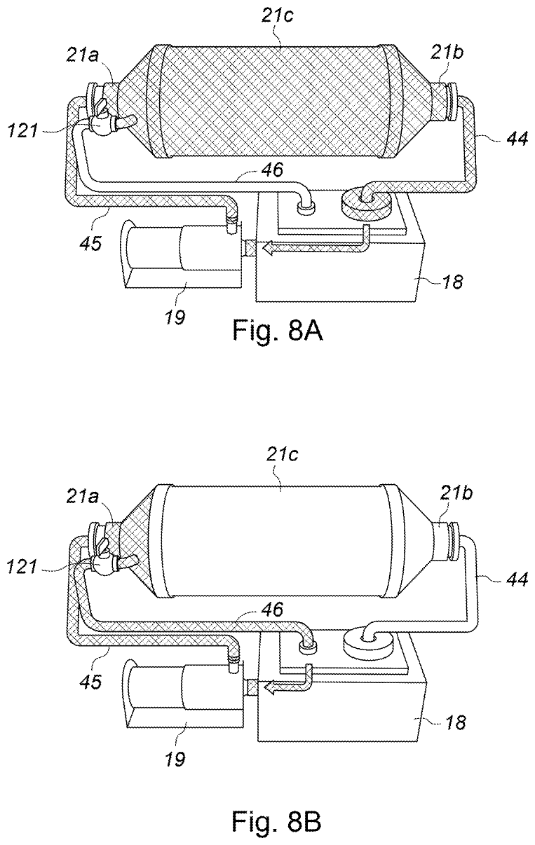

Referring to FIG. 8A, in an operational mode, the waste liquid (pre-filtered by unit 15) is circulated through the filtration membrane 21 between inlets and outlets 21a, 21b. The fluid flows from outlet 21b through conduit 44 and into tank 18. According to the specific implementation, tank 18 may comprise an internal slope and trap (not shown) to capture contaminants within the feed loop. Tank 18 may further comprise one or a plurality of filters. The feed loop waste liquid is then fed through pump 19 and returned to distillation inlet 21a via conduit 45. Conduit 45 comprises a heating coil/clamp (20—referring to FIG. 1) to maintain the feed loop temperature at around 60° C.

Referring to FIG. 8B, the present apparatus is configured for a cleaning mode to purge the filtration membrane 47 and dislodge and expel contaminants and impurities that accumulate internally within the feed loop and in particular within membrane distillation unit 21. A ball valve 121 is actuated to divert the fluid flow through conduit 46 to replace conduit 44 and outlet 21b of the operational loop of FIG. 8A. In the cleaning mode, the liquid flow enters and exits at the inlet end of the housing 21c to circulate through a part of tank 18 and pump 19 during the purge operation.

Referring to FIG. 10A, and as described previously, the liquid processing assembly 201 is compatible for operation with a variety of different types of membrane distillation materials and configurations. When implemented for DCMD, the membrane distillation unit 21 comprises a feed loop inflow 56 and feed loop outflow 55 and a corresponding permeate inflow 58 and outflow 57 with the two respective flow paths within distillation unit 21 separated by membrane 47. When implemented in an AGMD configuration unit 21 comprises the feed loop inflow and outflow 56, 57, a product outflow 59 and a cooling liquid inflow 63 and outflow 62. An internal condensation plate 61 and membrane 47 provides an air gap 60 between the respective feed and the cooling fluid flow pathways through unit 21. Referring to FIG. 10C and when implemented as a SGMD configuration, the distillation unit 21 comprises a supply inflow 56 and an outflow 55 and a corresponding sweep gas inflow 65 and sweep gas outflow 64 with the two internal flow paths separated by membrane 47. The sweep gas outflow 64 is coupled through a condenser 66 and a permeate collection 67. Referring to FIG. 10D when implemented as a VMD configuration, the distillation unit 21 comprises a feed loop supply inflow 56 and outflow 55 together with internal membrane 57. A vacuum manifold 68 is coupled to the partitioned second region within the distillation unit 21 to provide collection of the permeate via condenser 66.

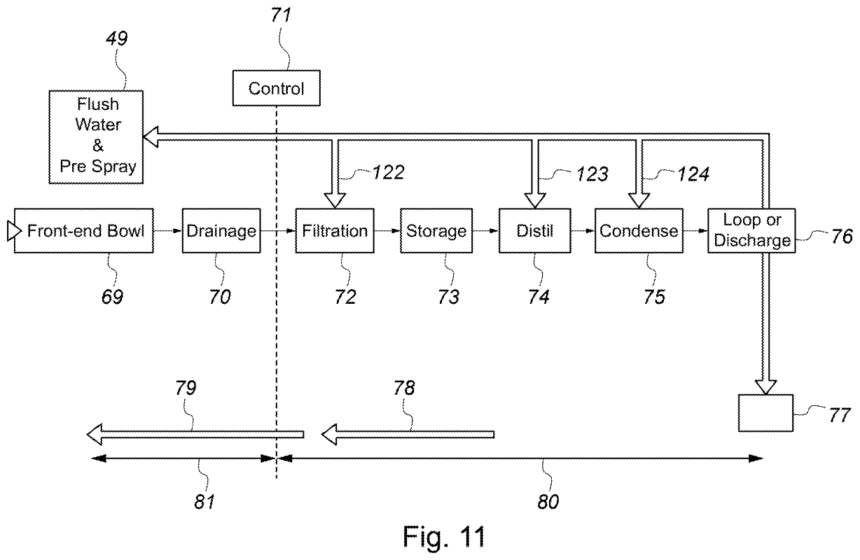

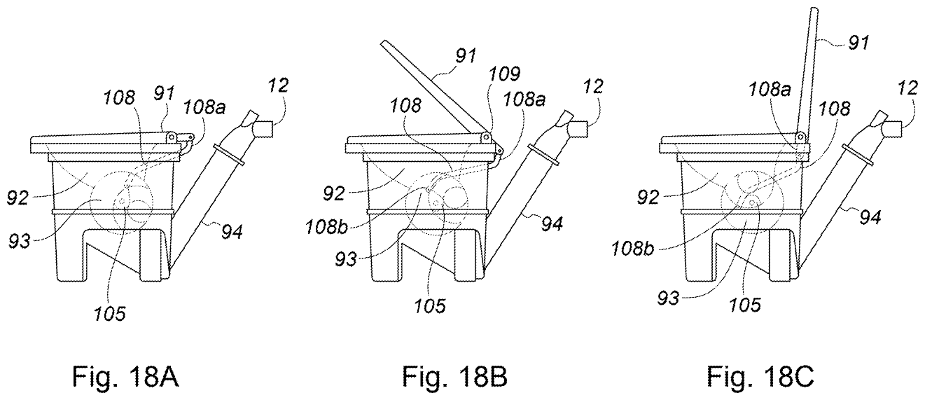

In operation and referring to FIG. 11, both solid and liquid human waste is deposited in toilet 11 at stage 69. A spray or flush water reservoir may be coupled to toilet 11 to provide flushing and rising of the toilet bowl via the supply reservoir at stage 49. The deposited solid and liquid waste is dispensed from the bowl into a toilet holding chamber (described referring to FIGS. 12 and 18A to 18C). A drainage port, filter and conveyor provide separation and drainage of the solid and liquid waste at stage 70 from the front end toilet. The diaphragm pump 13 then operates to deliver the predominantly liquid waste through manifold 14 to the pre-filtration unit 15 wherein the liquid is pre-filtered by a plurality of in-series flow filtration units. The pre-filtered liquid is then delivered to holding tank 18 at stage 73. The waste liquid is then transferred to membrane distillation unit 21 at stage 74 as a heated liquid feed loop. Condensate is then collected at stage 75 via the distillation and condensation cycle within the distillation unit 21 and via the simultaneous feed loop 22 and permeate loop 23 networks. The condensate is then collected within the permeate holding tank 27 at stage 76. The permeate may then be supplied to a finishing stage 77 in which the permeate is filtered through a charcoal, UV or other biological filter to remove biological species such as microbes, viruses, bacteria and the like. Stage 77 may also comprise filtering through appropriate filters to reintroduce nutrients into the permeate liquid for example to adjust pH and to introduce salts, ions, organic or inorganic compounds or biological species. Permeate holding tank 27 is provided with a weir overflow outlet 54 (FIG. 6) for the supply of permeate from tank 27 to the final stage 77. As described, the pre-filtration unit 15 may be purged of entrapped solid particulates via a back-wash loop liquid flow 79. Similarly, distillation unit 21 may be purged via a purge flow 78 to protect membrane distillation material by purging entrapped contaminant. The membrane distillation unit may be supplied with stored water via flow pathway 124 provided in fluid communication between the ‘front-end’ liquid reservoir and distillation unit 21. Accordingly, those components associated with stages 49, 69, 70 may be regarded as ‘front-end’ components 81 and those components associated with stages 72, 73, 74, 75, 76, 77, 122, 123 and 124 may be regarded as ‘back-end’ components 80. The purged concentrates may then be reused as a return flow 78 potentially to the initial front end fluid reservoir or for other uses such as tap and toilet water and as a backwash flow 79. The return flow of the purged concentrates includes solid particulates and these may be returned to the front end tank or the toilet chamber for cycled separation of solid and liquid matter via screw conveyor 42 and filter 41.

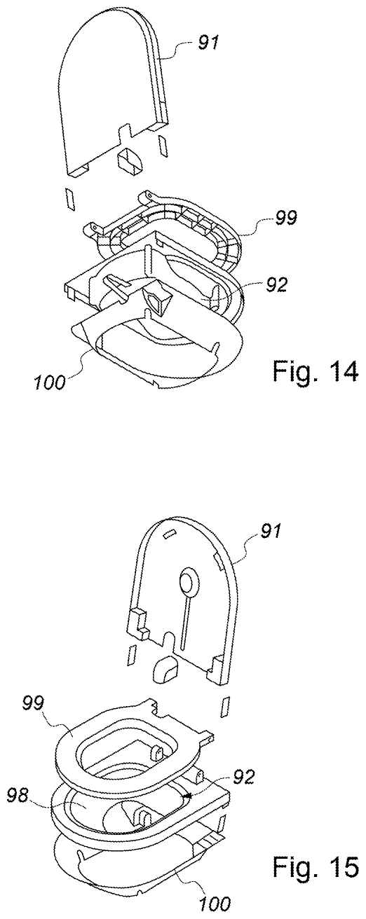

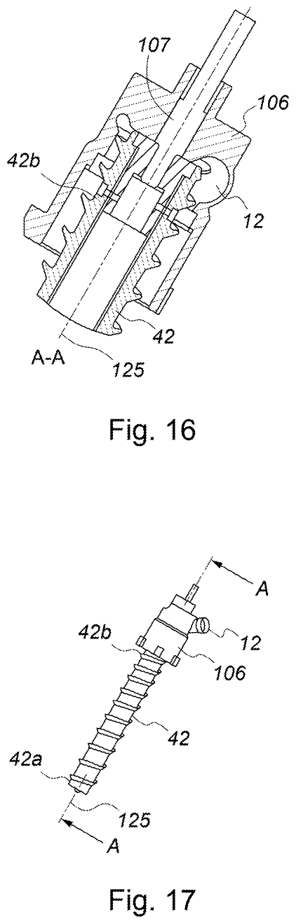

The front end toilet suitable for use within the present system 200 is described referring to FIGS. 12 to 18C. In particular, the human waste processing system 200 including the solid and liquid waste processing assemblies 202, 201 is compatible for use with a dry or semi-dry toilet (that requires little or no flushing water). According to the specific implementation, toilet 11 comprises a bowl indicated generally by reference 90 into which is deposited solid and liquid waste. Bowl 90 is divided into a generally stationary upper bowl part 92 and a rotatable lower bowl part 93. A cross-sectional area of the bowl 90 increases from a trough or lower region (defined by the rotatable lower bowl part 93) to the uppermost rim end of the stationary upper bowl part 92. Upper bowl part 93 comprises a bowl wall that defines an internal facing upper bowl surface 97 and lower bowl part 93 comprises a bowl wall having an internal facing lower bowl surface 98. Upper and lower bowl surfaces 97, 98 collectively define the open cavity or recess that is the receiving bowl 90. A toilet seat 99 is hingeably mounted together with a toilet lid 91 to sit over and about an uppermost rim of the upper bowl part 92. The upper and lower bowl parts 92, 93 are mounted and housed at least partially within a main toilet housing or frame 96. Housing 96 defines an internal solid and liquid waste receiving chamber 95. Referring to FIGS. 14 and 15, upper bowl part 92 is mounted at housing 96 via a seat flange 100. Referring to FIGS. 14 lower bowl part 93 is rotatably mounted at least partially within chamber 95 and at a generally upper region thereof. An elongate part cylindrical jacket 94 projects upwardly and rearwardly at an inclined angle from a lowermost region of chamber 95 and housing 96.

Referring to FIGS. 12, 16 and 17, screw conveyor 42 is rotatably mounted within jacket 94. Screw conveyor 42 is elongate and comprises a first end 42a extending into the lowermost region of chamber 95 and a second upper end 42b projecting upwardly and from housing 96 whilst being housed within jacket 94. A conveyor head 106 provides a hollow mounting to accommodate a drive motor and axel 107 for the rotational drive of screw conveyor 42 about axis 125. Head 106 comprises the outlet port 12 connectable to a solid waste collection tank (not shown).

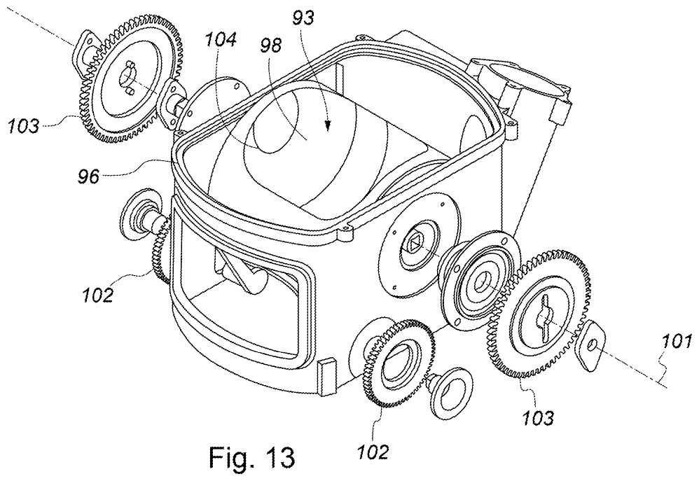

Referring to FIG. 13, bowl lower part 93 is rotatably mounted on rotational axis 101. In particular, lower bowl part 93 comprises a hollow drum-like configuration having an opening 104 into the internal cavity or recess that defines the lower region of bowl 90 via bowl surface 98. Surface 98 is continuously curved and is profiled so as to align or generally align with surface 97 of the upper bowl part when the lower bowl part 93 is rotated into a first position as illustrated in FIG. 12 to receive solid and liquid waste. That is, in this first position, the collective bowl surface is generally seamless to present a singular and continuous surface via the positional alignment of the respective lower and upper bowl surfaces 98, 97.

A driveable gear 103 is mounted either end of the rotatable drum-like body of the lower bowl part 93 externally at housing 96. A drive motor or other actuator (not shown) is mounted internally within housing 96 and comprises a drive axel (not shown) that extends through housing 96 to mount a corresponding driving gear 102. Drivable and driving gears 103, 102 are meshed such that actuation of the drive motor (not shown) provides a corresponding rotation of lower bowl part 93 about axis 101. In use, solid and liquid waste is deposited in bowl 90 and settles within the drum-like lower bowl part 93. Part 93 is then rotated about axis 101 within chamber 95. A rotational angle by which lower part 93 is rotated may be in the region 45° to 180° or more preferably at least 45° or at least 90° so as to empty the contents from lower bowl part 93 into chamber 95. The solid and liquid waste then settles within the lower part of chamber 95 in contact with the lower first end 42a of screw conveyor 42. The solid and liquid waste is then transported upwardly in the direction along axis 125. During this upward transport, the liquid and solid waste is separated via the use of filter 41 (referring to FIG. 5) provided in fluid communication with the liquid and solid waste slurry.

A further specific implementation of the front-end toilet is described referring to FIGS. 18A to 18C. The majority of the components and function described referring to FIGS. 12 to 17 are common to the further embodiment of FIGS. 18A to 18C. However, in place of the drive motor and gears 102, 103, rotation of the lower bowl part 93 is provided by a mechanical arm actuator 108. Actuator 108 comprises a first end 108a pivotally mounted to lid 91 and a second end 108b pivotally connected to the lower bowl part 93 via a cam 105. Accordingly, as lid 91 is pivoted about an axis 109, actuator 108 is translated upwardly and laterally so as to rotate lower bowl part 93 about axis 101. That is, in the receiving position of FIG. 18C with the lid 91 in the ‘open’ position, surfaces 97 and 98 align whilst in the lid ‘closed’ position of FIG. 18A, the lower bowl part 93 is rotated at an angle of around 120° to empty the contents of bowl 90 into chamber 95. The lid 91 may then be pivoted and the toilet 11 returned to a status ready for use.

As will be appreciated, the various mechanical, electromechanical, electrohydraulic pumps, valves and components of the system 200 may be controlled via suitable control unit 71 (FIG. 11). Control unit 71 may comprise conventional local or remote computer systems including processors, memory, human interface, data storage, wired and wireless communication for remote to cloud data transfer and wired or wireless control of the various electromechanical components of the system 200. The present system 200 via control unit 71 may be operational for fully automatic, semi-automatic or manual operation of the various pumps, valves, heating units etc associated and incorporated within both the liquid and solid processing assemblies 201, 202. The system 200 may further comprise a plurality of different types of sensor located at various positions within the system 200 for operational status monitoring and feedback. Such sensors may include liquid and gas flow sensors, temperature sensors, pH sensors, pressure sensors, biological sensors, motion sensors, proximity or contact sensors etc. In particular, the toilet 11 may comprise one or a plurality of sensors to detect waste deposited into bowl 90 and/or chamber 95 so as to provide automatic actuation of screw conveyor 42 and pump 13. Similarly, membrane distillation unit 21 may be controlled via control unit 71 including in particular control of pump 19, heater 20, pump 25 and purge components 28 and operation via specific sensors at unit 21. The purge operation associated with the pre-filtration unit 15 may similarly be controlled by control unit 71 including control of the valves 34, 37, 38, 39 via specific sensors. Level sensors within tanks 16a, 17a, 18, 27, 32 and 95 may provide associated feedback and control of one or more components to avoid capacity filling of the tanks which would otherwise render the system inoperable. Accordingly, the present system 200 may comprise suitable safety liquid outflow ports at one or a plurality of positions associated with the above-mentioned tanks and storage chambers and reservoirs. Such safety outflow ports may be coupled to a suitable manifold for discharge or transport to a further master holding tank.

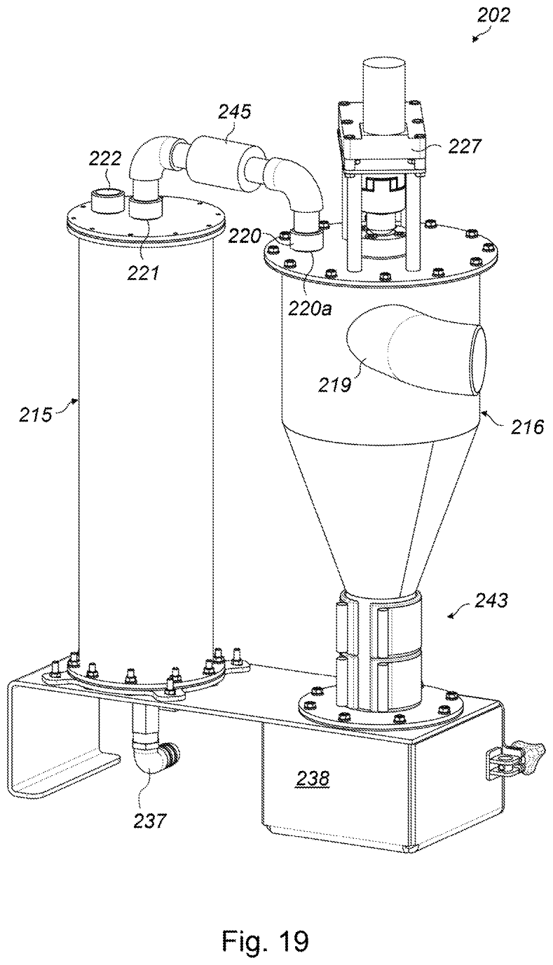

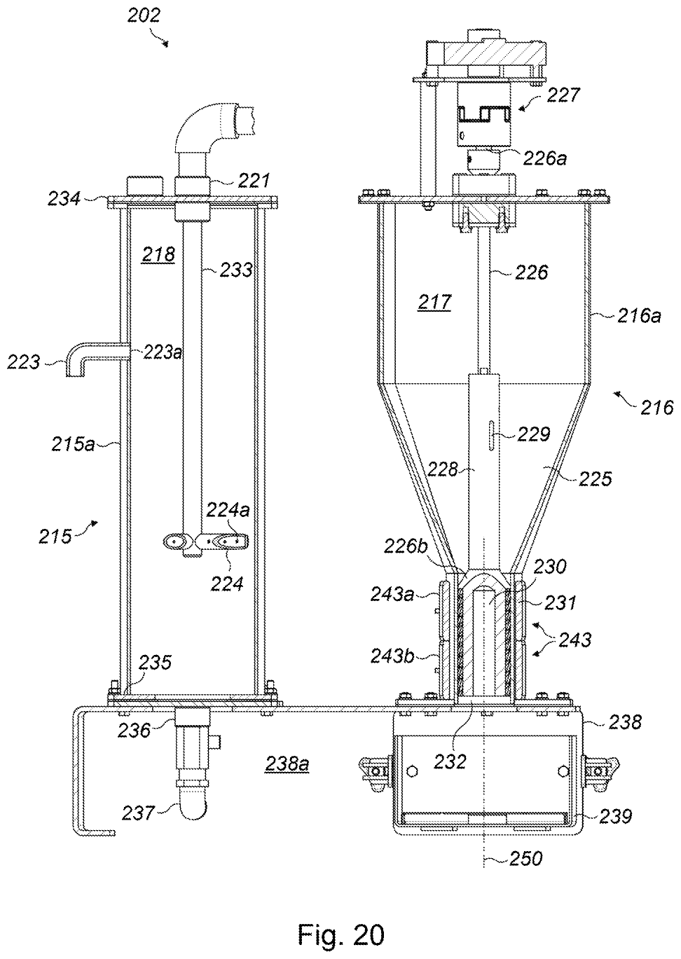

The apparatus and method for predominantly solid waste processing is now described referring to FIGS. 19 to 24. Referring initially to FIG. 19, the pyrolysis and emission scrubber module 210 is configured specifically for the processing and treatment of predominantly solid waste (faeces/faecal matter). The primary components of the module 210 comprise the pyrolysis unit 216, the emission scrubber 215, a char collection trap 238, a heater 243, a gas/moisture vapour conduit 245 providing fluid communication between the pyrolysis unit 216 and the emission scrubber 215 in addition to various inlets and outlets, as described herein. In particular, and referring to FIGS. 19 and 20, the emission scrubber 215 comprises a liquid containment tank 215a. Tank 215a and chamber 218 are elongate and comprise a first upper end 234 and a second lower end 235. Lower end 235 is mounted to char collection trap 238 that provides a support or mounting platform. Pyrolysis unit 216 is also coupled to the char collection trap 238 such that both units 216, 215 are mounted side-by-side.

The emission scrubber 215 comprises a gas/moisture vapour inlet defined generally by reference 221. Inlet 221 comprises an elongate inlet tube 233 that extends from the first upper end 234 towards second lower end 235. A lower terminal end of tube 233 comprises a radial flange 224 having a series of apertures 224a. Flange 224 is accordingly positioned in a lower half of chamber 218 closer towards second lower end 235 relative to first upper end 234. Tank 215a also comprises a liquid outlet 223 in which an aperture 223a of liquid outlet 223 is positioned coplanar with the cylindrical wall of tank 215a that defines internal chamber 218. Liquid outlet 223 is positioned in a lengthwise direction between ends 234, 235 just above a mid-length position so as to be in an upper half of tank 215a and chamber 218. Emission scrubber 215 also comprises a gas/moisture vapour outlet indicated generally by reference 222 located at the first upper end 234. Accordingly, the gas/moisture vapour inlet 221, and in particular an inlet aperture 224a of inlet 221, is positioned towards or in close proximity to the second lower end 235 whilst the gas/moisture vapour outlet 222 is positioned at or in close proximity to first upper end 234. Liquid outlet 223 is positioned in a lengthwise direction intermediate inlet aperture 224a and gas outlet 222.

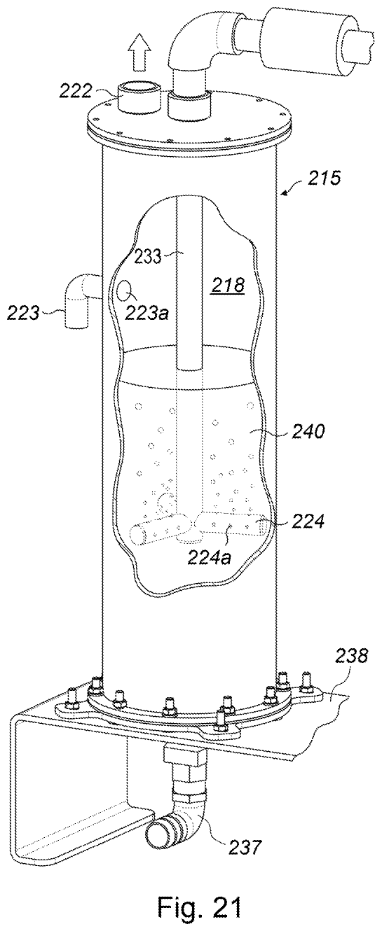

Referring to FIG. 21, emission scrubber 215 is configured to collect and contain a scrubber liquid 240 occupying a lower region of the tank 215a. Accordingly, flange 224 and gas inlet aperture 224a is configured to be submerged within the scrubber liquid 240.

Referring again to FIGS. 19, 20, 22 and 23, pyrolysis unit 216 comprises a vessel 216a defining an internal chamber 217. An upper region of chamber 217 is generally cylindrical whilst a lower region of chamber 217 is generally conical defining an internal conical guide surface 225. At a region below guide surface 225, chamber 217 comprises a radially reduced cylindrical section that in turn defines a lower heating zone 231 of the pyrolysis unit 216. Zone 231 is surrounded by a heating jacket 243. According the specific implementation, heater (heating jacket) 243 is divided into a lower heating collar 243b and an upper heating collar 243a with both collars 243a, 243b axially and circumferentially encapsulating zone 231. Zone 231 is positioned immediately above and in internal communication with char collection trap 238.

Pyrolysis unit 216 also comprises an internal waste actuator indicated generally by reference 226. Actuator 226 is generally elongate and comprises a first end 226a that projects upwardly from vessel 216a and is mounted within an electric motor indicated generally by reference 227. An opposite second end of actuator 226 is radially enlarged relative to the actuator main length to define an actuating drum 230, rotatably mounted within zone 231. An upper end of drum 230 comprises a conical section 226b tapering radially inward towards the main length of actuator 226 and in opposite tapered relationship relative to the radially inward tapered surface 225 extending from the upper cylindrical section of vessel 216a. Actuator 226 is hollow to comprise an internal bore 228 extending over at least half of its lower length from a lower end 232 through zone 231, conical section 225 and into the upper cylindrical section. At least one vent port 229 provide fluid communication with the internal chamber 217 and the internal bore 228 for the passage of gas.

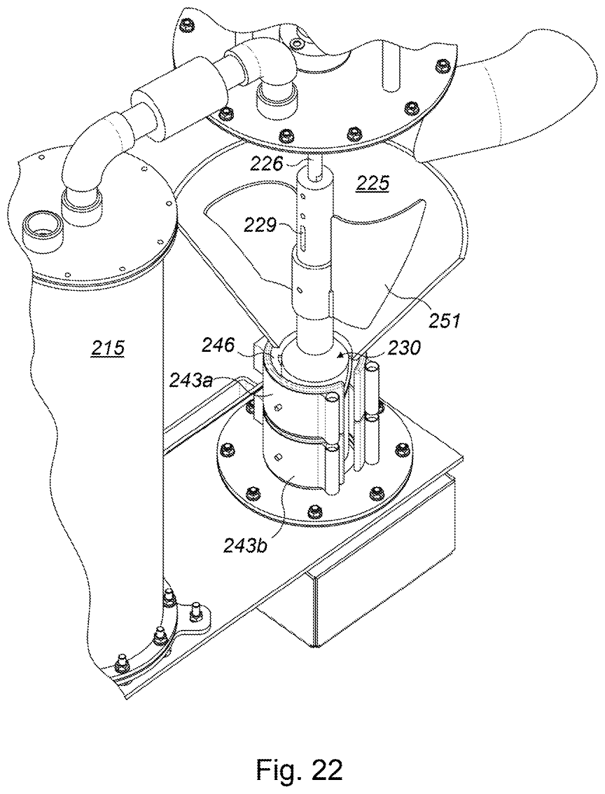

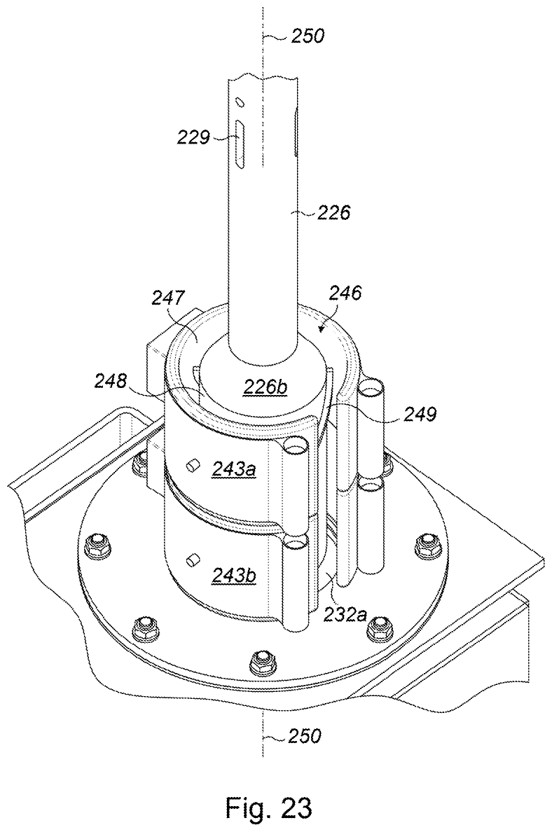

Referring specifically to FIGS. 22 and 23, at least one helical rib 249 projects radially outward from an external facing surface 248 of drum 230, with rib 249 extending helically about a longitudinal rotational axis 250 of actuator 226. Vessel 216a at the heating zone 231 comprises a corresponding cylindrical internal facing surface 247 so as to create an annular gap region indicated generally by reference 246 between the respective cylindrical surfaces 248 and 247. The at least one helical rib 249 projects radially into the gap region 246 from drum 230. An annular aperture 232a is defined between a lengthwise lower terminal end of drum 230 and the corresponding lengthwise lower terminal end of zone 231 corresponding approximately to an upper surface of char collection trap 238.

Accordingly, aperture 232a provides internal communication between an internal chamber 238a of trap 238 and internal chamber 217 of vessel 216a. Char collection trap 238 comprises a removable tray 239 for removing char deposited in trap 238 from chamber 217.

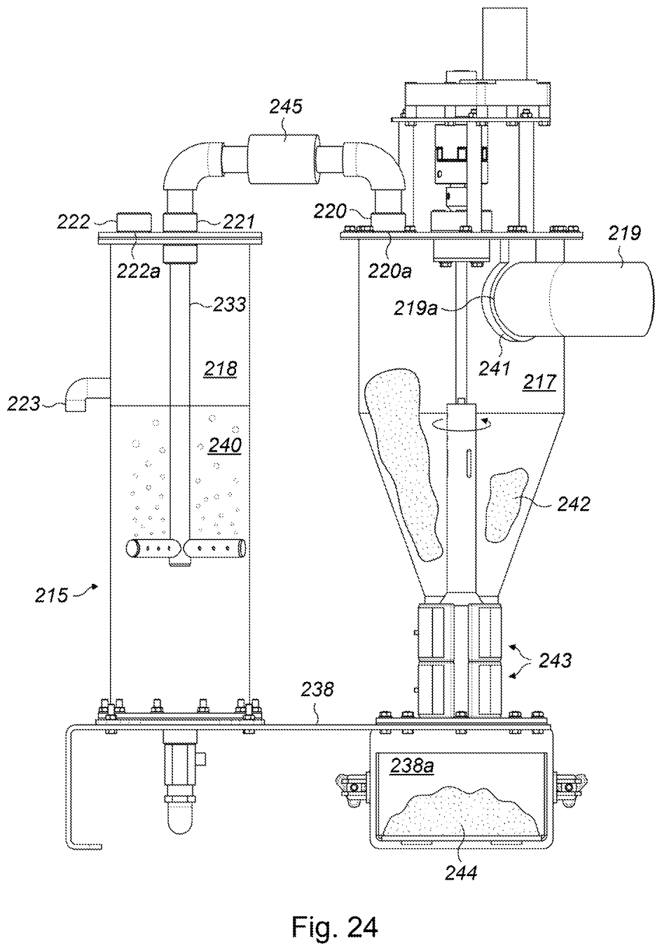

Pyrolysis unit 216 further comprises a solid matter inlet port 219 and a gas/moisture vapour outlet 220. Solid matter inlet 219, referring to FIG. 24, comprises an inlet aperture 219a from which solid matter is configured to be deposited within chamber 217.

A hingeably mounted flap 241 is positioned to extend across aperture 219a and is forced to hinge open as solid matter is transported towards and through inlet 219/inlet aperture 219a. As illustrated in FIGS. 19 and 24, solid waste inlet 219 is positioned towards an upper end of vessel 216a such that solid matter (indicated generally by reference 242) falls downwardly under gravity towards and in contact with conical guide surface 225. Gas/moisture vapour outlet 220 also comprises an outlet aperture 220a positioned at or near the upper end of vessel 216a.

In use, predominantly solid waste matter is transported from toilet 212 via transporter 214 to the pyrolysis emission scrubber module 210. The solid matter is received at the pyrolysis unit 216 via inlet 219. Predominant solid matter 242 is then deposited within chamber 217 to fall under gravity and collect at the generally funnel shaped guide surface 225. Unit 216 may comprise suitable electronic sensors (for example motion, moisture, pressure, contact, temperature sensors etc) to provide/facilitate actuation of motor 227 and a corresponding rotation of actuator 226 within chamber 217 about axis 250. Accordingly, drum 230 is configured to rotate within zone 231. Solid matter 242 via the conical guide surface 225 is encouraged to fall under gravity into the annular region 246 between drum 230 and jacket heater 243. During this initial stage, at least one of the heating collars 243a, 243b is actuated to provide modest heating of the solid matter 242 within chamber 217 and in particular any solid matter within gap region 246. Alternatively, at least one of the heating collars 243a, 243b may be actuated so as to providing heating of gap region 246 and internal chamber 217 prior to rotational drive of actuator 226. In a preferred implementation, actuator 226 is rotated counter clockwise so as to provide a ‘churn’ effect on the solid matter 242 with the helical rib 249 inhibiting downward movement of the solid matter 242 through the heating zone 231.

This initial drying phase is preferably operated at around 70° C. and is configured to remove water and oxygen within solid matter 242. Importantly, restricting this drying process to not more than 70° C. is advantageous to avoid release of nitrogen and sulphur compounds from the solid matter 242. This initial drying phase may be undertaken for 30 minutes to 2 hours whilst actuator 226 is rotated counter clockwise. Oxygen and water vapour are driven from chamber 217 through the gas outlet 220, conduit 245 and tube 233 to be exhausted into the scrubber liquid 240 via aperture 224a. In a preferred implementation, scrubber 215 may be ‘primed’ with a scrubber liquid for example by introducing a predefined volume of liquid into tank 215a. The initial drying phase of the present concept is further advantageous to replenish the scrubber liquid 240 within tank 215a and in particular to dilute the scrubber liquid 240 with freshwater condensate. This pre-pyrolysis heating phase (at the modest temperature below that of the subsequent pyrolysis heating phase) is beneficial to firstly maintain a predefined volume of scrubber liquid 240 within tank 215a and also to inhibit the scrubber liquid 240 becoming too acidic due to elevated concentrations of nitrogen and sulphur containing compounds. Importantly, as inlet aperture 224a of the scrubber 215 is submerged within scrubber liquid 240 oxygen, water vapour and any product gases driven and released from solid matter 242 during this drying phase (and the subsequent torrefaction phase) are exhausted directly into the scrubber liquid 240 where they are at least partially solvated/dissolved. As indicated, the volume of scrubber liquid 240 is maintained at a predetermined level via the presence and position of liquid outlet 223 positioned intermediate inlet aperture 224a and the gas/moisture vapour outlet 222.

Pyrolysis within chamber 217 is achieved via appropriate fluid seals and valves at the various inlet and outlet ports. In particular, solid waste inlet port 219 (having hinge flap 241) comprises a perimeter region (not shown) that is profiled so as to sit in close fitting contact with aperture 219a and provide a fluid seal. Additionally, solid matter transported to the inlet 219 acts as a ‘bung’ to effectively inhibit the ingress of oxygen at chamber 217. As chamber 217 is provided in open fluid communication with char collection trap 238 and in particular trap chamber 238a, trap 238 comprises appropriate seals (not shown) again to prevent oxygen ingress into chamber 217. A one-way valve (not shown) is provided within conduit 245 to prevent the return-flow of gas, in particular oxygen and water vapour, from the scrubber 215 into chamber 217. Appropriate seals are also provided around actuator 226 at first end 226a of mounting at the external drive motor 227.

As the initial drying phase approaches completion, the predetermined volume of scrubber liquid 240 within tank 215a is achieved with any excess scrubber liquid allowed to drain via the liquid outlet 223. Any excess liquid may then be supplied to the liquid treatment module 213 including filtration unit 213b. As indicated, this is effective to maintain a predetermined pH and to minimise the accumulation of dissolved nitrogen and sulphur compounds within scrubber liquid 240. Scrubber 215 also comprises a liquid drain outlet 236 and conduit 237 for connection to an output tank or liquid treatment module 213. This is useful to empty tank 215a for maintenance purposes or to completely refresh the scrubber liquid 240.

Once substantially all the oxygen and moisture are expelled from the solid waste 242, the system is then adapted to the second pyrolysis phase. Actuator 226 is rotated in a clockwise direction to facilitate downward movement of the dried solid waste 242 into the heating zone 231. A scrapper 251 extends radially outward from the elongate main shaft of actuator 226 repositioned in near or close touching contact with conical surface 225 so as to contact solid matter 242 as actuator 226 is rotated. The rotational speed of actuator 226 is controlled such that when combined with gravity, the solid waste 242 is transported at a predetermined speed in a downward direction through the heating zone 231 as the heating collars 243a, 243b are actuated. The present system is configured specifically for the controlled heating of the solid matter 242 to inhibit/minimise the generation of harmful Syngas gas emissions including NOₓ, SOₓ, CO and NH₃. The minimised emission of these gases is achieved by a combination of the exhausting of all product gases into the scrubber liquid 240 and a configuration of the heating zone 231 and the method/parameters by which the solid matter 242 is heated within chamber 217 and in particular zone 231. Preferably, the present system is configured for the torrefaction of the solid waste 242 being a mild form of pyrolysis. Preferably, the heating collars 243a, 243b are actuated to achieve a heating temperature of less than 250° C. and preferably a heating temperature of around 200° C. being sufficient to destroy bacteria and viruses within solid matter 242. As the solid matter falls under gravity into the heating zone it is transported downwardly to the annular aperture 232a by helical rib 249. Gases generated from the heating of the biomass 242 are also pushed downwardly through the annular heating zone 231. These gases flow via annular aperture 232a into the hollow open end and interior of actuator drum 230 to then flow upwardly through bore 228 where they are vented into chamber 217 via vent port 229. Providing this exhaust gas pathway from the annular heating zone 231 internally through the drum 230 and actuator 226 prevents blockage of the downward movement of the biomass 242 within the annular heating zone 231 that may otherwise occur due to pressure build-up at this region.

The gases generated from the torrefaction of the biomass 242 are exhausted directly into the scrubber liquid 240 via aperture 224a that is submerged within liquid 240. Any NOₓ, SOₓ, CO, NH₃ generated from the torrefaction are at least partially absorbed by scrubber liquid 240. Optionally, an alkaline mesh or brick insert may be mounted within tank 215a to counter the reducing pH levels resultant from the absorbed gases. Additionally, a similar filter insert may be provided at the upper region of chamber 218 internally or externally relative to gas/moisture vapour outlet 222 so as to provide a scrubbing of any gases vented from chamber 218. Optionally, the scrubber 215 may comprise a carbon or activated carbon/charcoal scrubber cartridge.

The biomass 242 having been heated continuously whilst being transported axially downward through the annular heating zone 231 is then deposited as char 244 into the char collection chamber 238a. This char 244 falls under gravity from annular aperture 232a and is also encourages to move downwardly and be expelled from zone 231 via the helical rib 249 that effective to maintain a modest agitation of the solid matter 242 within the heating zone 231. The char 244 may then be removed from trap chamber 238a via a removable tray and door (not shown) provided at trap 238.

The drying and pyrolysis (torrefaction) sequential stages may then be repeated to replenish and dilute the scrubber liquid 240 (by condensation of water vapour within chamber 217) and to thermally decompose the biomass 242. The present system is advantageous to regenerate and replenish the scrubber liquid 240 via the initial drying phase whilst also destroying bacteria and viruses within the biomass 242 during the subsequent low temperature pyrolysis. The present system via maximum heating temperatures of the order of around 200° C. is energy efficient and adapted to control and minimises harmful gas emissions such as NOₓ, SOₓ, CO, NH₃.

Referring to FIGS. 2A and 2B, an operation of the human waste processing system 200 is now described. Solid and liquid waste are deposited within pan and bowl interface 90 and subsequently into the rotating bowl mechanism 93 of toilet 11. The mixed solid and liquid waste falls under gravity into the lower tank 95. According to the specific implementation the pan and bowl interface 90 is provided with a cascade pre-wetting mechanism 130 and the rotating bowl mechanism 93 is provided with a nozzle spray 131. Mixed solid and liquid waste is then transferred to the waste actuator 42 having the integrated filter 41 to separate solid and liquid waste. Rotational drive of the actuator 42 is provided by motor 131a. Liquid waste is directed to the pre-filter unit 15 via liquid port 14A, pump 13 and conduit/manifold 14. In parallel, solid waste is transferred to the pyrolysis module 216 via solid outlet 12 and flap 241 provided at solid waste inlet 219. The liquid waste treatment then proceeds, as described, involving pre-filtration via the pre-filtration unit 15 and subsequent filtration via the membrane distillation unit 21 configured to output a permeate/distillate via a final polishing step 31, with the permeate/distillate being collected at holding tank 134.

Fluid flow conduits 135, 136 are coupled respectively to the pre-filter unit 16 and 17 at a first end and the lower tank 95 of the toilet 11 via an intermediate conduit 137 coupled to each of the conduits 135, 136. Conduits 135, 136 and 137 provide coupling of the pre-filter units 16 and 17 to the toilet 11 to allow purging of entrapped solid matter at the pre-filtration unit 15 via the purge operation to return this solid and liquid waste to the toilet 11. Additionally, holding tank 134 is coupled via conduits 138 and 139 to each of the respective cascade pre-wetting 130 and nozzle spray 131 mechanisms to provide a supply of filtered liquid to the toilet 11 for flushing purposes and to reuse the treated liquid waste. Drive of the filtered liquid from holding tank 134 through conduits 138, 139 is provided by respective pumps 132, 133. Additionally, the purge components 28 coupled to the membrane distillation unit 21 are also coupled at the downstream end to the conduit 137 that returns the purged solid and liquid waste back to the toilet 11 and in particular the lower tank 95.

As indicated, the predominantly solid waste is processed by the solid waste processing assembly 202 described referring to FIGS. 19 to 24 in which solid waste is initially dried via an initial drying stage and the subsequent torrefaction processing within pyrolysis module 216. The scrubber liquid is generated and continually regenerated via the drying and torrefaction processing to avoid the scrubber liquid becoming increasingly acidic as the exhausted emissions from the pyrolysis module 216 are vented directly into the liquid scrubber module 215 and in particular the scrubber liquid via one way valve 245. The product solid char collected within char collection trap 238 may then be extracted for disposal or subsequent use 250. Emission scrubber module 215 and in particular the liquid outlet of the module 215 is connected in fluid communication to the liquid waste processing assembly 201 and in particular conduit 40 that extends between the outlet 17B of pre-filtered tank 17A and the warm feed holding tank 18. Accordingly, liquid output from the emission scrubber module 215 may be supplied directly to the holding tank 18 for subsequent processing through the membrane distillation unit 21. Additionally, the scrubber liquid 240 is capable of being drained and returned to lower tank 95 of toilet 11 via liquid drain outlet 236 and conduit 251. For example, should the scrubber liquid 240 become too acidic or for maintenance purposes, the liquid may be drained quickly into the lower tank 95 via conduit 251. Emission scrubber module 215 is also connected to the membrane distillation unit 21 and in particular the distillate/permeate loop 23. This provides the optional supply of permeate/distillate to the emission scrubber module 215 to provide liquid top-up or an overflow function as required.

1. Waste processing apparatus comprising:
a) a liquid waste processing assembly comprising:
at least one pre-filter treatment unit having a liquid flow inlet and outlet and a particulate filter to separate particulate suspended within waste liquid;
a membrane distillation unit having a membrane distillation vessel with an internal filter membrane, a primary flow liquid inlet and outlet and a permeate flow outlet, the primary flow liquid inlet connected in fluid communication to the liquid flow outlet of the pre-filter treatment unit; and
b) a solid waste processing assembly comprising:
a pyrolysis unit having at least one heater and a pyrolysis chamber provided with a solid waste inlet, a solid waste outlet, a gas/moisture vapour outlet; and
a scrubber unit having a scrubber tank to contain a scrubber liquid and provided with a liquid outlet, a gas outlet and a gas/moisture vapour inlet coupled to the gas/moisture vapour outlet of the pyrolysis chamber.

2. The waste processing apparatus as claimed in claim 1 comprising:
a toilet having a toilet outlet coupled to the liquid flow inlet of the pre-filter treatment unit and the solid waste inlet of the pyrolysis unit.

3. The apparatus as claimed in claim 1 further comprising a mixed waste actuator to transport and/or separate the solid and liquid waste, the actuator positioned in a waste flow direction between the toilet outlet and said liquid flow inlet and said solid waste inlet.

4. The apparatus as claimed in claim 1 further comprising a holding tank coupled to or provided at the toilet to receive and/or store solid and liquid waste, the liquid flow outlet of the pre-filter treatment unit coupled to the holding tank.

5. The apparatus as claimed in claim 1 wherein the liquid outlet of the scrubber unit is coupled to the primary flow liquid inlet of the membrane distillation unit.

6. The apparatus as claimed in claim 4 comprising a liquid drain conduit coupling in fluid communication the scrubber unit and the holding tank to enable transfer of a scrubber liquid from the scrubber unit to the holding tank.

7. The apparatus as claimed in claim 2 wherein the permeate flow outlet is coupled in fluid in communication to the toilet to enable a supply of a permeate liquid from the membrane distillation unit to the toilet.

8. The apparatus as claimed in claim 1 wherein the pre-filter treatment unit comprises:
a first pre-filter treatment unit having a first pre-filter storage tank and a first particulate filter; and
a second pre-filter treatment unit having a second pre-filter storage tank and a second particulate filter.

9. The apparatus as claimed in claim 8 wherein
the first particulate filter comprises a first mesh pore size; and
the second particulate filter comprises a second mesh pore size being less than the first mesh pore size.

10. The apparatus as claimed in claim 4 wherein the pre-filter treatment unit comprises a respective purge valve and purge outlet connected in fluid communication to the particulate filter, the apparatus further comprising at least one return flow conduit extending between the front end holding tank and the pre-filter treatment unit to provide a filtration circuit.

11. The apparatus as claimed in claim 1 further comprising a solid-liquid coarse filter to separate solid waste from the waste liquid positioned in a fluid flow direction upstream of the pre-filter treatment unit.

12. The apparatus as claimed in claim 1 further comprising a flow actuator, optionally comprising a pump, connected in a fluid flow direction between the solid-liquid coarse filter and the pre-filter treatment unit.

13. The apparatus as claimed in claim 1 further comprising a holding tank positioned in a fluid flow direction between the pre-filter treatment unit and the membrane distillation unit.

14. The apparatus as claimed in claim 1 further comprising:
a first distillation flow pump to drive a flow of liquid from the holding tank to the membrane distillation unit;
a permeate collection reservoir to collect liquid permeate output from the permeate flow outlet;
wherein the membrane distillation unit further comprises a permeate flow inlet connected in fluid flow with the permeate flow outlet to provide a permeate flow loop through the filter membrane;
a second distillation flow pump connected in fluid flow with the permeate flow loop.

15. The apparatus as claimed in claim 1 wherein the scrubber tank comprises a scrubber liquid and an aperture of the gas/moisture vapour inlet from which a gas/moisture vapour is configured to enter is positioned submerged within the scrubber liquid and an aperture of the gas outlet through which a gas is configured to vent from the scrubber tank is positioned above and clear of the scrubber liquid; and
wherein an aperture of the liquid outlet from which a liquid is configured to flow from the scrubber tank is positioned intermediate the aperture of the gas/moisture vapour inlet and the aperture of the gas outlet.

16. The apparatus as claimed in claim 1 wherein the pyrolysis unit further comprises a waste actuator positioned within the chamber to compress and/or facilitate movement of the waste to a region of the chamber adjacent the heater.

17. The apparatus as claimed in claim 1 wherein at least a portion of the chamber and the actuator are cylindrical and separated from one another by an annular gap region, the actuator being rotatably mounted within the chamber.

18. The apparatus as claimed in claim 17 wherein the heater is positioned to at least partially surround the chamber at a location adjacent the annular gap region.

19. The apparatus as claimed in claim 16 wherein an external facing surface of the actuator is positioned opposite an internal facing surface of the chamber and comprises at least one helical rib extending lengthwise around the longitudinal axis of the actuator; and
wherein the actuator is elongate and hollow and comprises an internal gas flow conduit extending from a first end towards a second end wherein the first end is open to provide an inlet of the internal gas flow conduit and positioned at or towards a lower region of the chamber, the actuator further comprising vent apertures positioned at or towards the second end of the actuator to provide an outlet of the internal gas flow conduit and enable a gas to vent from the internal gas flow conduit and into a region of the chamber surrounding the actuator.

20. The apparatus as claimed in claim 1 wherein the pyrolysis unit comprises valves and/or seals to prevent or inhibit a flow of air into the chamber so as to provide an oxygen depleted environment within the chamber suitable for pyrolysis.

21. A method of processing human waste comprising:
a) processing liquid waste via a liquid waste processing assembly including:
receiving liquid waste from a toilet at a pre-filter treatment unit;
filtering the waste liquid at the pre-filter treatment unit using a particulate filter;
transferring filtered waste liquid from the pre-filter treatment unit to a membrane distillation unit;
filtering the waste liquid through a filter membrane within a membrane distillation vessel of the membrane distillation unit; and
outputting liquid permeate from the membrane distillation unit; and
b) processing solid waste via a solid waste processing assembly including:
thermally decomposing solid waste within a chamber using pyrolysis;
exhausting a flow of a gas from said chamber generated by the pyrolysis into a body of a scrubber liquid contained within a scrubber tank, the scrubber tank positioned in internal fluid communication with the chamber.

22. The method as claimed in claim 21 further comprising transporting and/or separating the solid and liquid waste using a mixed waste actuator, the actuator positioned in a waste flow direction between an outlet of the toilet and a liquid flow inlet of the at least one pre-filter treatment unit and a solid waste inlet of the pyrolysis unit; and/or
prior to the step of filtering the waste liquid at the pre-filter treatment unit, filtering the waste liquid via a solid-liquid coarse filter to separate solid waste from waste liquid, a mesh pore size of the solid-liquid coarse filter being greater than a mesh pore size of the particulate filter of the pre-filter treatment unit.

23. The method as claimed in claim 21 further comprising:
purging solid waste entrapped at the pre-filter treatment unit via a purge valve connected to the pre-filter treatment unit; and
transferring the solid waste purged from the pre-filter treatment unit via a return flow conduit to a front-end holding tank and/or an inlet of the pre-filter treatment unit.

24. The method as claimed in claim 21 comprising drying the solid waste within the chamber prior to the step of thermally decomposing the solid waste, wherein a heating temperature of the step of drying is less than a heating temperature of the step of thermally decomposing the solid waste.

25. The method as claimed in claim 24 further comprising collecting water within the scrubber tank during the step of drying the solid waste to generate the scrubber liquid within the scrubber tank; and
maintaining a pre-determined volume of water within the scrubber tank by allowing excess water to exit the scrubber tank via a liquid outlet positioned to provide a weir arrangement at the scrubber tank.

26. The method as claimed in claim 24 wherein the heating temperature of the step of drying is in a range 30° C. to 150° C., 40° C. to 120° C., 40° C. to 100° C. or 50° C. to 90° C.; and/or a heating temperature of the step of thermally decomposing is in a range 180° C. to 400° C., 200° C. to 400° C., 200° C. to 300° C. or 220° C. to 270° C.

27. The method as claimed in claim 24 wherein during the step of drying and/or thermally decomposing the solid matter, the method further comprises compressing the solid matter within the chamber by moving the solid matter into a gap region within the chamber defined between an external facing surface of a rotating waste actuator extending within the chamber and an internal facing surface of the chamber.

28. The method as claimed in claim 21 wherein gas and/or moisture vapour generated within the chamber is exhausted exclusively into the body of the scrubber liquid prior to any exhausting of a gas and/or moisture vapour from the scrubber tank.
